(19) United States
(12) Patent Application Publication
(10) Pub. No.: US 2021/0058970 A1
(43) Pub. Date: Feb. 25, 2021

(54) MECHANISMS TO OPERATE ON A DOWNLINK WIDEBAND CARRIER IN UNLICENSED BAND

(71) Applicant: Intel Corporation, Santa Clara, CA (US)

(72) Inventors: Yongjun Kwak, San Diego, CA (US); Lopamudra Kundu, Sunnyvale, CA (US); Salvatore Talarico, Sunnyvale, CA (US); Yingyang Li, Beijing (CN)

(21) Appl. No.: 17/091,579

(22) Filed: Nov. 6, 2020

Related U.S. Application Data
(60) Provisional application No. 62/933,053, filed on Nov. 8, 2019.

(51) Int. Cl. H04W 74/08; H04W 74/00; H04W 72/04; H04W 24/08; H04W 76/27

(52) U.S. Cl. CPC H04W 74/0816; H04W 74/008; H04W 72/0453; H04W 72/0493; H04W 24/08; H04W 76/27; H04W 72/042

(57) ABSTRACT

Various embodiments herein provide techniques to operate wideband (WB) cells, and in particular, WB operation for New Radio-Unlicensed (NR-U). The embodiments herein provide more accurate and efficient operation of WB procedures with listen-before-talk (LBT) operation as compared with existing and/or previous solutions. In embodiments, a user equipment (UE) may receive configuration information for a search space set that includes multiple monitoring locations in a frequency domain within a listen-before-talk (LBT) bandwidth part (BWP). The UE may monitor for a physical downlink control channel (PDCCH) on one or more of the monitoring locations

### CROSS REFERENCE TO RELATED APPLICATION

The present application claims priority to U.S. Provisional Patent Application No. 62/933,053, which was filed Nov. 8, 2019; the disclosure of which is hereby incorporated by reference.

### FIELD

Embodiments relate generally to the technical field of wireless communications.

### BACKGROUND

Mobile communication has evolved significantly from early voice systems to today's highly sophisticated integrated communication platform. The next generation wireless communication system, (e.g., 5G or New Radio (NR)) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP Long Term Evolution (LTE)-Advanced with additional potential new radio access technologies (RATs) to enrich people lives with better, simple and seamless wireless connectivity solutions. NR will enable everything connected by wireless and deliver fast, rich contents and services.

One major enhancement for LTE in Release (Rel)-13 had been to enable the operation of cellular networks in the unlicensed spectrum, via licensed-assisted access (LAA). Ever since, exploiting the access of unlicensed spectrum has been considered by 3GPP as one of the promising solutions to cope with the ever increasing growth of wireless data traffic. One of the important considerations for LTE to operate in unlicensed spectrum is to ensure fair co-existence with incumbent systems like wireless local area networks (WLANs), which has been the primary focus of LAA standardization effort since Rel. 13.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a configuration for wideband operation in accordance with various embodiments.

FIG. 2 illustrates transmission of a group common (GC)-physical downlink control channel (PDCCH) for indicating available listen-before-talk (LBT) bandwidth (BW), in accordance with various embodiments.

FIG. 3 illustrates multiple monitoring locations for the same control resource set (CORESET), in accordance with various embodiments.

FIG. 4 illustrates multiple monitoring locations for the same CORESET with guardband, in accordance with various embodiments.

FIG. 5 illustrates an adjustment of a physical downlink shared channel (PDSCH) based on LBT outcomes, in accordance with various embodiments.

FIG. 6 illustrates an example architecture of a system of a network, in accordance with various embodiments.

FIG. 7 illustrates an example of infrastructure equipment in accordance with various embodiments.

FIG. 8 illustrates an example of a computer platform in accordance with various embodiments.

FIG. 9 illustrates example components of baseband circuitry and radio front end modules in accordance with various embodiments.

FIG. 10 is a block diagram illustrating components, according to some example embodiments, able to read instructions from a machine-readable or computer-readable medium (e.g., a non-transitory machine-readable storage medium) and perform any one or more of the methodologies discussed herein.

FIG. 11 is a flowchart of an example process in accordance with various embodiments.

FIG. 12 is a flowchart of another example process in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Following the trend of LTE enhancements, a study item (SI) on NR based access to unlicensed spectrum (NR-unlicensed) has been started in 3GPP Rel-15. Within the scope of this SI, one of the primary objectives is to identify additional functionalities that are needed for a physical (PHY) layer design of NR to operate in unlicensed spectrum. In particular, it is desirable to minimize the design efforts by identifying the essential enhancements needed for Rel-15 NR design to enable unlicensed operation, while avoiding unnecessary divergence from Rel-15 NR licensed framework. Coexistence methods already defined for LTE-based LAA context should be assumed as the baseline for the operation of NR-unlicensed systems, while enhancements over these existing methods are not precluded. NR-based operation in unlicensed spectrum should not impact deployed Wi-Fi services (data, video and voice services) more than an additional WiFi network on the same carrier.

NR-unlicensed technologies can be categorized into different modes including Carrier Aggregation (CA), Dual Connectivity (DC), and Standalone (SA) modes of network operation. The channel access mechanism aspect is one of the fundamental building blocks for NR-unlicensed that is essential for any deployment options. The adoption of LBT in LTE based LAA system was crucial in achieving fair coexistence with the neighboring systems sharing the unlicensed spectrum in addition to fulfilling the regulatory requirements. The LBT based channel access mechanism fundamentally resembles the WLAN's CSMA/CA principles. Any node that intends to transmit in unlicensed spectrum first performs a channel sensing operation before initiating any transmission. An additional random back-off mechanism is adopted to avoid collisions when more than one nodes senses the channel as idle and transmits simultaneously.

In NR-Unlicensed, one cell can have the carrier bandwidth (BW) larger than 20 MHz like the NR wideband (WB) operation. However, due to the licensed band restriction, the LBT has to be performed based on 20 MHz subband, which is called LBT BW. Since there can be multiple LBT BWs inside one cell for WB operation, the operation may depend on how many LBT BWs are available to be used by performing separate LBT. For this purpose, the NR-U study/work item description defines the WB operation as follows:

Wide band operation (in integer multiples of 20 MHz) for DL and UL for NR-U supported with multiple serving cells, and wideband operation (in integer multiples of 20 MHz) for DL and UL for NR-U supported with one serving cell with bandwidth >20 MHz with potential scheduling constraint subject to input from RAN2 and RAN4 on feasibility of operating the wideband carrier when LBT is unsuccessful in one or more LBT bandwidths within the wideband carrier. For all wide-band operation cases, CCA is performed in units of 20 MHz (at least for 5 GHz).

The present disclosure provides mechanism to operate WB cells, and in particular, WB operation for NR-U. The embodiments herein provide more accurate and efficient operation of WB procedures with LBT operation as compared with existing and/or previous solutions.

Mechanisms to Operate Downlink Transmission for Wideband Cell

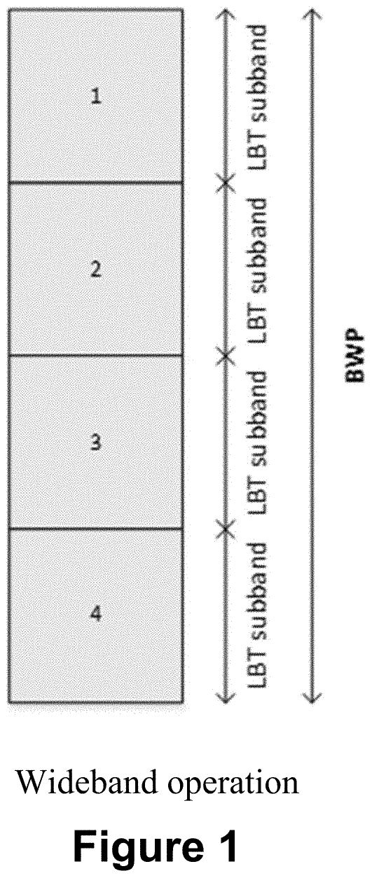

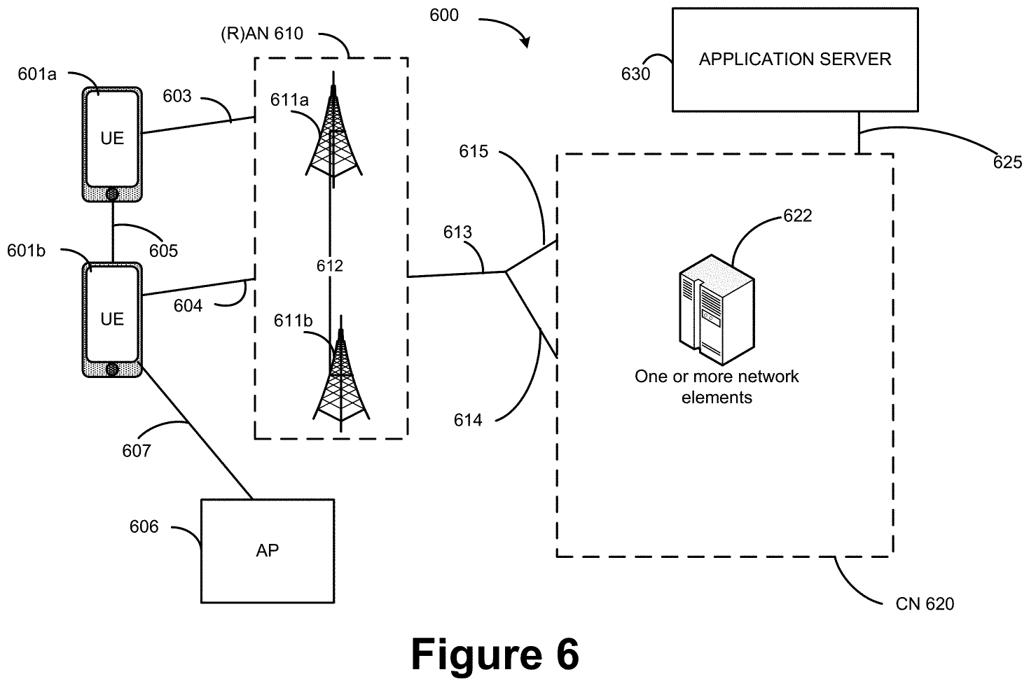

FIG. 1 shows an example WB configuration, where one active BWP is configured for a UE (e.g., UE 601 of FIG. 6), which is larger than 20 MHz. Inside the active BWP, there can be multiple LBT BWs, for example, 4 LBT BWs in BWP as shown in FIG. 1. Here, the terminology of “LBT subband” can be also used instead of “LBT bandwidth,” “LBT BW,” or the like.

WB operation depends on how many LBT BWs are available to be used due to successful LBT outcomes. For DL WB operation, multiple options are given below:
Option 1a: Multiple BWPs configured, multiple BWPs activated, transmission of PDSCH on one or more BWPs.
Option 1b: Multiple BWPs configured, multiple BWPs activated, transmission of PDSCH on single BWP.
Option 2: Multiple BWPs can be configured, single BWP activated, gNB transmits PDSCH on a single BWP if CCA is successful at gNB for the whole BWP.
Option 3: Multiple BWPs can be configured, single BWP activated, gNB transmits PDSCH on parts or whole of single BWP where CCA is successful at gNB.

Option 1a and 1b needs multiple active BWPs but option 2 and 3 can operate under a single active BWP. The main difference between option 2 and option 3 is the condition of the PDSCH transmissions. For option 2, PDSCH can be transmitted over the whole BWP if CCA is successful for all LBT BWs. For option 3, PDSCH can be transmitted over the part of BWP where CCA is successful. For option 2, operation is simple since any of the LBT BWs fails CCA, then nothing is transmitted in DL. However, for option 3, available subbands for PDSCH transmission depends on the CCA of each LBT BW. And also, if some LBT BW fail CCA inside the BWP, the adjacent LBT BW may get some interferences from the device which is using the subband. Therefore, certain guard band may need to be considered for the edge of the available subbands for option 3.

Indication of Available LBT BW

It has been agreed to support a mechanism for the UE to detect whether a gNB (e.g., RAN node 611 of FIG. 6) is transmitting across multiple carriers or multiple LBT BWs in a carrier. For this purpose, it is desirable to explicitly indicate the gNB's transmitted LBT BWs to the UEs since blind detection of available LBT BWs may not be sufficiently reliable and can lead to many unnecessary operation for the error case. Furthermore, the UE blind detection itself will bring additional implementation burden. In embodiments, DCI format 2_0/group common PDCCH (GC-PDCCH) may be used to indicate a COT structure.

GC-PDCCH is used to carry at least slot format related information. DCI format 2_0 is used for notifying the slot format. DCI format 2_0 with CRC scrambled by SFI-RNTI includes 1-N slot indicators (e.g., Slot format indicator 1, Slot format indicator 2, . . . , Slot format indicator N) where N is a number. The size of DCI format 2_0 is configurable by higher layers up to 128 bits, according to subclause 11.1.1 of 3GPP TS 38.213. In various embodiments, DCI format 2_0 also carries an indication of the COT structure in the time domain.

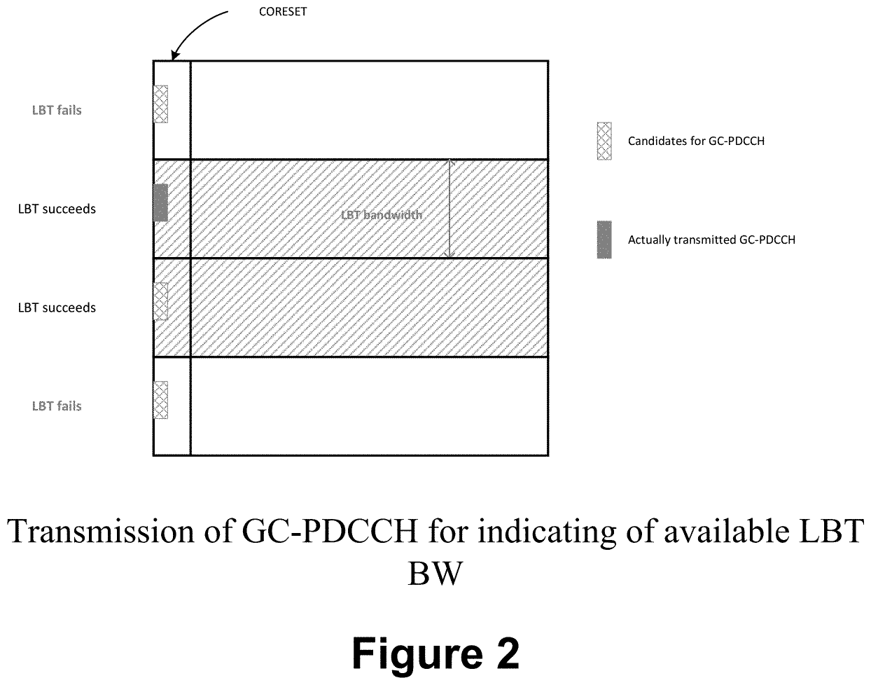

In some embodiments, DCI format 2_0 is used for available LBT BW information (frequency domain COT structure) as well as time domain COT structure. If the available LBT BW information is transmitted in DCI format 2_0 via GC-PDCCH, clarification may be needed regarding the LBT BW in which the GC-PDCCH is transmitted since there are some LBT BWs that are available and remaining LBT BWs are not available for the transmission GC-PDCCH. It may be assume that each LBT BW includes at least one CORESET and it can be assumed that at least one PDCCH candidate for GC-PDCCH is configured for each LBT BW. In these embodiments, the gNB transmits the GC-PDCCH in one of the PDCCH candidates, which is positioned within available LBT BW as shown by FIG. 2.

In some embodiments, for CA scenario between licensed band and unlicensed band (e.g., LAA scenario), it is also possible to transmit the GC-PDCCH using licensed band in order not to configured multiple PDCCH candidates for GC-PDCCH and to provide higher reliability of GC-PDCCH.

If the indication is supported in the DCI format 2_0 via GC-PDCCH in one of the available LBT BWs, additional procedures can be defined, such as those discussed below.

CORESET Configuration of Wideband Operation

In one embodiment, for the configuration of the CORESET which corresponds to GC-PDCCH, cluster-based configuration is supported. Cluster-based configuration is that CORESET resources are split for each LBT BW and each LBT BW has some part of CORESET resource. Then there can be PDCCH candidates that are confined within each LBT BW. Therefore even though one single CORESET is configured, GC-PCCH can be transmitted using the PDCCH candidate which is confined with the LBT BW where LBT is successful.

In one embodiment, for the cluster-based configuration, at least one PDCCH candidate may need to be guaranteed considering only one single LBT BW is available by LBT outputs. Therefore the number of PDCCH candidates per each aggregation level of PDCCH needs to be at least equal to the number of LBT BW. As shown below as an example, for DCI 2_0, the number of PDCCH candidate needs to be 5 considering 5 LBT BWS in 100 MHz BW carrier.

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2, n3, n4, n5} OPTIONAL, |

-- Need R

| | |
|---|---|
| aggregationLevel2 | ENUMERATED { n1, n2, n3, n4, n5} OPTIONAL, -- |

Need R

| | |
|---|---|
| aggregationLevel4 | ENUMERATED { n1, n2, n3, n4, n5} OPTIONAL, -- |

Need R

| | |
|---|---|
| aggregationLevel8 | ENUMERATED { n1, n2, n3, n4, n5} OPTIONAL, -- |

Need R

| | |
|---|---|
| aggregationLevel16 | ENUMERATED { n1, n2, n3, n4, n5} OPTIONAL -- |

Need R

},
...

| | |
|---|---|
| } | OPTIONAL, -- Need R |

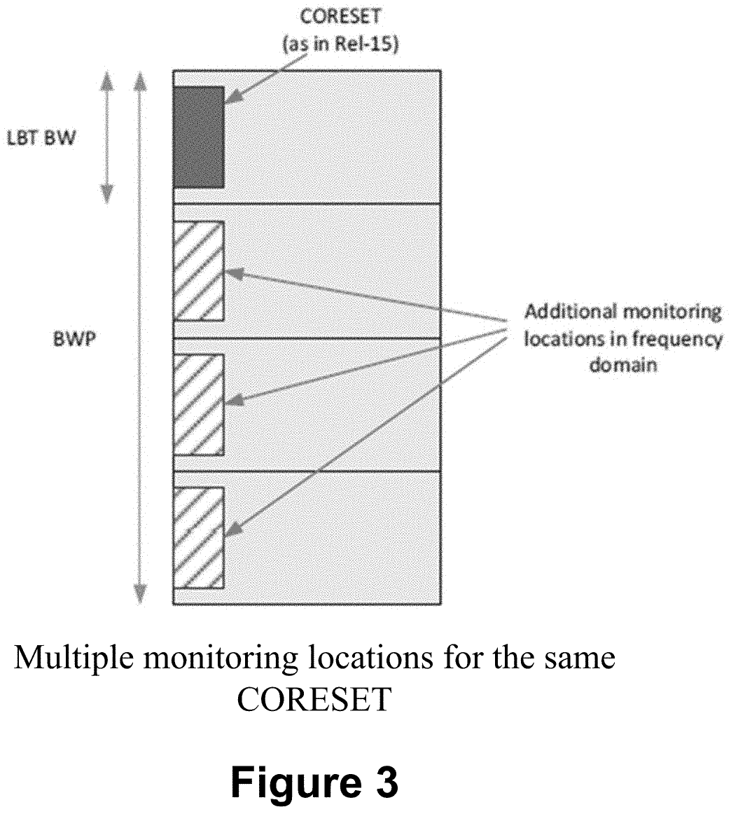

In one embodiment, for the case where a CORESET is confined within a LBT bandwidth, the search space set configuration associated with the CORESET can have multiple monitoring locations in the frequency domain (per LBT bandwidth). FIG. 3 is showing how CORESET can be configured with the agreement, where one CORESET is configured as done in Rel-15 with the restriction that CORESET spans inside a single LBT BW and additional monitoring locations with the same CORESET properties except frequency locations are configured in search space. In order to support multiple monitoring locations in the frequency domain, following options for RRC parameters can be considered.

Option 1) monitoringSubband-r16 parameter is introduced in Searchspace and it shows which LBT subband has to be monitored inside multiple LBT subbands and only one CORESET is configured for a single LBT subband. BITMAP is used for monitoringSubband-r16 and each bit of the bitmap corresponds to one LBT subband, where Max_Subband is the number of LBT subbands that can be configured. Corresponding RRC parameters are shown below.

-- ASN1START
-- TAG-SEARCHSPACE-START

| | |
|---|---|
| SearchSpace ::= | SEQUENCE { |

| | |
|---|---|
| searchSpaceId | SearchSpaceId, |

| | | |
|---|---|---|
| controlResourceSetId | ControlResourceSetId | OPTIONAL, |

-- Cond SetupOnly

| | |
|---|---|
| monitoringSlotPeriodicityAndOffset | CHOICE { |

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

| | |
|---|---|
| } | OPTIONAL, -- Cond Setup |

| | | |
|---|---|---|
| duration | INTEGER (2..2559) | OPTIONAL, -- |

Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| monitoringSubband-r16 | BIT STRING (SIZE (2..MAX_Subband) ) |

| | |
|---|---|
| searchSpaceType | CHOICE { |

| | |
|---|---|
| common | SEQUENCE { |

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

OPTIONAL -- Need R

},
...

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |

| | |
|---|---|
| dummy1 | ENUMERATED {sl1, sl2, sl4, sl5, sl8, sl10, sl16, sl20} |

OPTIONAL, -- Cond Setup

| | |
|---|---|
| dummy2 | ENUMERATED {n1, n2}, |

...

| | |
|---|---|
| } | OPTIONAL -- Need R |

| }, | |
|---|---|
| ue-Specific | SEQUENCE { |

| | |
|---|---|
| dci-Formats | ENUMERATED {formats0-0-And-1-0, formats0-1-And- |

1-1},

...

}

| | |
|---|---|
| } | OPTIONAL -- Cond Setup |

}
-- TAG-SEARCHSPACE-STOP
-- ASN1STOP

Option 2) monitoringSubband-r16 parameter is introduced in Searchspace and it shows which LBT subband has to be monitored inside multiple LBT subbands and only one CORESET is configured for a single LBT subband. BITMAP is used for monitoringSubband-r16 and each bit of the bitmap corresponds to 6 PRB which is the unit of CORESET. Each bit of BITMAP indicates the starting point of CORESET that need to be monitored. Corresponding RRC parameters are shown below.

-- ASN1START
-- TAG-SEARCHSPACE-START

| | |
|---|---|
| SearchSpace ::= | SEQUENCE { |

| | |
|---|---|
| searchSpaceId | SearchSpaceId, |

| | | |
|---|---|---|
| controlResourceSetId | ControlResourceSetId | OPTIONAL, |

-- Cond SetupOnly

| | |
|---|---|
| monitoringSlotPeriodicityAndOffset | CHOICE { |

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

| | |
|---|---|
| } | OPTIONAL, -- Cond Setup |

| | | |
|---|---|---|
| duration | INTEGER (2..2559) | OPTIONAL, -- |

Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| monitoringSubband-r16 | BIT STRING ( size(45) ) |

| | |
|---|---|
| searchSpaceType | CHOICE { |

| | |
|---|---|
| common | SEQUENCE { |

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

OPTIONAL -- Need R

},
...

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SSEQUENCE { |

...

| | |
|---|---|
| } | OPTIONAL, -- Need R |

| | |
|---|---|
| dci-Format2-3 | SSEQUENCE { |

| | |
|---|---|
| dummy1 | ENUMERATED {sl1, sl2, sl4, sl5, sl8, sl10, sl16,sl20} |

OPTIONAL, -- Cond Setup

| | |
|---|---|
| dummy2 | ENUMERATED {n1, n2}, |

...

| | |
|---|---|
| } | OPTIONAL, -- Need R |

| }, | |
|---|---|
| ue-Specific | SEQUENCE { |

| | |
|---|---|
| dci-Formats | ENUMERATED {formats0-0-And-1-0, formats0-1-And- |

1-1},

...

}

| | |
|---|---|
| } | OPTIONAL -- Cond Setup |

}
-- TAG-SEARCHSPACE-STOP
-- ASN1STOP

Option 3) monitoringSubband-r16 parameter is introduced in Searchspace and it shows which LBT subband has to be monitored inside multiple LBT subbands and only one CORESET is configured for a single LBT subband. Multiple offset values are indicated by monitoringSubband-r16 and each offset indicates the offset of additional monitoring locations in frequency domain with respect to the original CORESET. Corresponding RRC parameters are shown below.

-- ASN1START
-- TAG-SEARCHSPACE-START

| | |
|---|---|
| SearchSpace ::= | SEQUENCE { |

| | |
|---|---|
| searchSpaceId | SearchSpaceId, |

| | | |
|---|---|---|
| controlResourceSetId | ControlResourceSetId | OPTIONAL, |

-- Cond SetupOnly

| | |
|---|---|
| monitoringSlotPeriodicityAndOffset | CHOICE { |

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

| | |
|---|---|
| } | OPTIONAL, -- Cond Setup |

| | | |
|---|---|---|
| duration | INTEGER (2..2559) | OPTIONAL, -- |

Need R

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| monitoringSubbandOffset-r16 | SEQUENCE (SIZE (1..5)) OF INTEGER (0..45) |

| | |
|---|---|
| searchSpaceType | CHOICE { |

| | |
|---|---|
| common | SEQUENCE { |

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

OPTIONAL -- Need R

},
...

| } | | OPTIONAL, -- Need R |
|---|---|---|
| dci-Format2-1 | SEQUENCE { | |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |

| | |
|---|---|
| dummy1 | ENUMERATED {sl1, sl2, sl4, sl5, sl8, sl10, sl16, sl20} |

OPTIONAL, -- Cond Setup

| | |
|---|---|
| dummy2 | ENUMERATED {n1, n2}, |

...

| | |
|---|---|
| } | OPTIONAL -- Need R |

| }, | |
|---|---|
| ue-Specific | SEQUENCE { |

| | |
|---|---|
| dci-Formats | ENUMERATED {formats0-0-And-1-0, formats0-1-And- |

1-1},

...

}

| | |
|---|---|
| } | OPTIONAL -- Cond Setup |

}
-- TAG-SEARCHSPACE-STOP
-- ASN1STOP

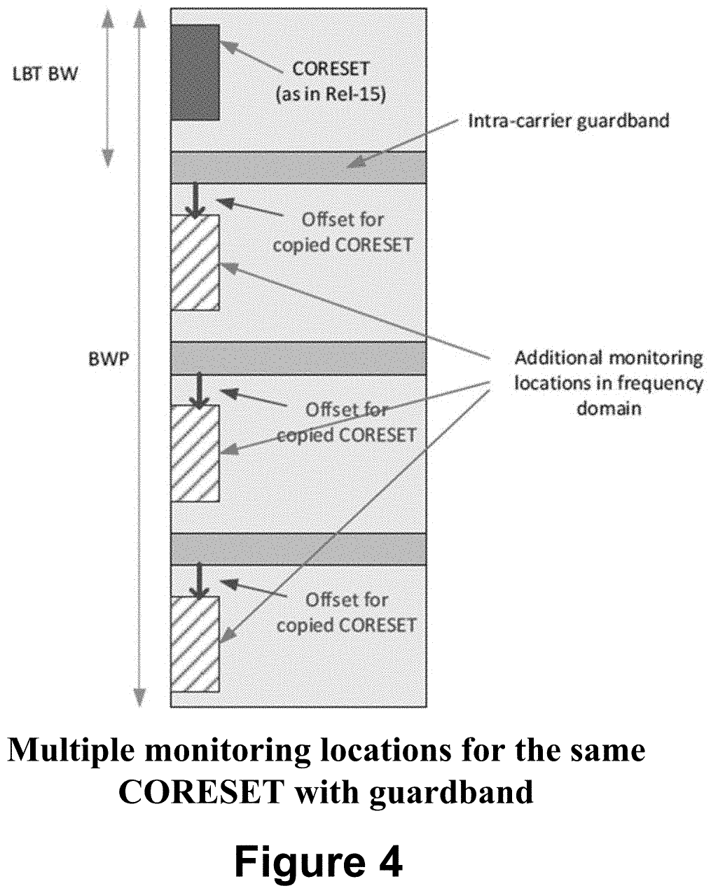

In one embodiment, For utilization of the available RBs in each LBT BW, 6RB allocation from CRB#0 is applied only for the CORESET configuration as done in Rel-16, but it is preferred to utilize the RB level offset from the boundary of the configured guardband to define the starting position of the additional monitoring locations of the CORESET as shown in FIG. 4 Multiple monitoring locations for the same CORESET.

RRC parameter to configure the offset from guardband can be defined like below

-- ASN1START
-- TAG-SEARCHSPACE-START

| | |
|---|---|
| SearchSpace ::= | SEQUENCE { |

| searchSpaceId | SearchSpaceId, | |
|---|---|---|
| controlResourceSetId | ControlResourceSetId | OPTIONAL, |

-- Cond SetupOnly
CHOICE {

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| s1320 | INTEGER (0..319), |
| s1640 | INTEGER (0..639), |
| s11280 | INTEGER (0..1279), |
| s12560 | INTEGER (0..2559) |

| | |
|---|---|
| } | OPTIONAL, -- Cond Setup |

| | | |
|---|---|---|
| duration | INTEGER (2..2559) | OPTIONAL, -- |

Need R

monitoringSymbolsWithinSlot

| | |
|---|---|
| OPTIONAL, -- Cond Setup | BIT STRING (SIZE (14)) |

| | |
|---|---|
| nrofCandidates | SEQUENCE { |

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| monitoringSubbandOffset-r16 | SEQUENCE (SIZE (1..5)) OF INTEGER (0..106) |

| | |
|---|---|
| searchSpaceType | CHOICE { |

| | |
|---|---|
| common | SEQUENCE { |

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |

| | |
|---|---|
| nrofCandidates-SFI | SEQUENCE { |

| | |
|---|---|
| aggregationLevel1 | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

OPTIONAL -- Need R

},
...

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |

| | |
|---|---|
| dummy1 | ENUMERATED {sl1, sl2, sl4, sl5,sl8,sl10,sl16,sl20} |

OPTIONAL, -- Cond Setup

| | |
|---|---|
| dummy2 | ENUMERATED {n1, n2}, |

...

| | |
|---|---|
| } | OPTIONAL -- Need R |

| }, | |
|---|---|
| ue-Specific | SEQUENCE { |

| | |
|---|---|
| dci-Formats | ENUMERATED {formats0-0-And-1-0, formats0-1-And- |

1-1},

...

}

| | |
|---|---|
| } | OPTIONAL -- Cond Setup |

}
-- TAG-SEARCHSPACE-STOP
-- ASN1STOP

In one embodiment, based on gNB implementation, the GC-PDCCH may not be prepared in the beginning of the gNB acquired COT. In that case, in some embodiments, the GC-PDCCH may be transmitted in the next monitoring occasions of GC-PDCCH. Therefore, in these embodiments, the gNB may configure multiple monitoring opportunities for GC-PDCCH inside the COT.

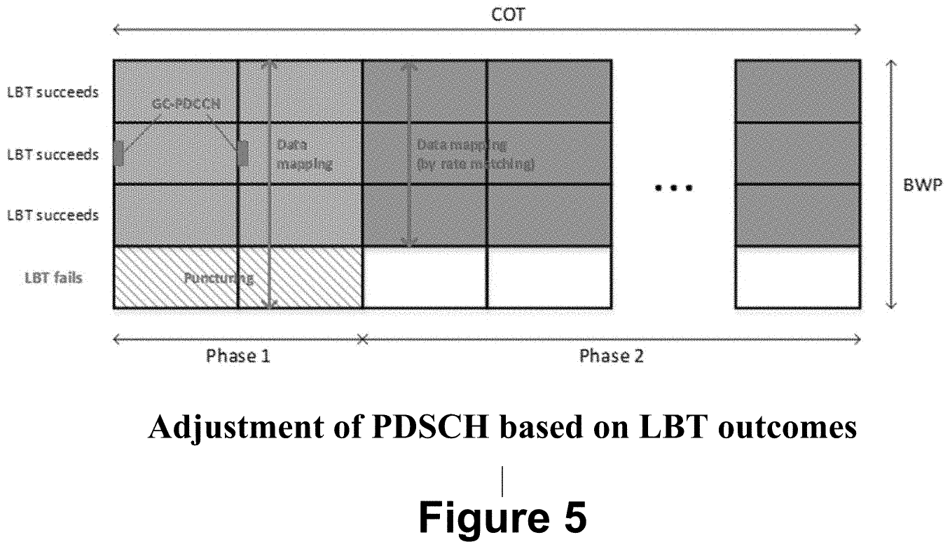

In another embodiment, it may not be easy to reformat the PDSCH based on LBT outcomes. Therefore, in some embodiments, in the first one or a few slots (phase 1), the PDSCH is mapped assuming that whole BWP is available and gNB may puncture the LBT BW where CCA is not successful. After sufficient time for gNB, the gNB can adjust the PDSCH according to the available LBT BWs in the remaining time of the same COT (phase 2) as shown by FIG. 5.

In another embodiment, as shown by FIG. 5, the UE may try to receive whole BW during phase 1. However, the UE may try to blindly detect which LBT BWs are available using DMRS or try to decode GC-PDCCH as fast as possible and perform the decoding using the knowledge of the punctured parts. In some embodiments, during Phase 2, the UE knows which LBT BWs are available and performs rate-matching around the LBT BW, which is not available due to LBT failure.

In one embodiment, DCI 2_0 includes available LBT bandwidth information as BITMAP of N bits, where N is the same as the number of LBT bandwidth (20 MHz) and each bit of the BITMAP indicates whether the LBT is successful in the corresponding LBT bandwidth or not.

In one embodiment, DCI 2_0 includes available LBT bandwidth information as N bits, where N is indicating any combination of the available LBT bandwidths inside the carrier. In one embodiment, if the LBT outcome is not available due to the time constraint, the gNB can indicate that all LBT bandwidths are available. In another embodiment, if the LBT outcome is not available due to the time constraint, the gNB can indicate that LBT outcome is not available yet by reserving 1 state of N bits. In another embodiment, if the LBT outcome is not available due to the time constraint, the gNB can indicate that all LBT bandwidths are not available. In another embodiment, available LBT bandwidth information is configured by higher layer, e.g., what kinds of combination of available LBT BW is indicated.

In other embodiments, for the transmission of PUSCH in UL, the UE may try to use whole scheduled BW for the encoding of PUSCH. Then, the UE may puncture the data which is mapped to LBT BW where CCA is not successful. For UL, there can be just one phase and only puncturing can be applied for the LBT BW where CCA is not successful during the whole COT duration.

In other embodiments, as allowed by the regulatory requirements, a primary channel is defined. The selection of the primary channel can be left to gNB's implementation or it can be chosen uniformly among a raster of available channels or it can be fixed. In this context, the GC-PDCCH with indication of the LBT BW is always carried within the primary channel and may not be prepared in the beginning of the gNB acquired COT. In this case the DL transmission over the active BWP is always conditional to the success of the LBT over the primary channel. A UE always expect transmission over the primary channel, and only in case the primary channel is not known a priori and in this case except for the first DL burst for which has to perform blind detection to determine the primary channel, in all the subsequent DL bursts, the primary channel will always be located on the same channel: regulatory requirements only dictate that the primary channel cannot be changed more than once a second, but does not limit the amount of time the same channel can be used as a primary channel. The UE behaviour in this case is as follows: phase 1) UE attempt to find the primary channel by detecting the DMRS and/or decoding the GC-PDCCH, unless the primary channel is known a priori or has been already detected in a prior DL burst, and in this case it can simply decode the GC-PDCCH without any blind detection and extract the information related to the LBT BW; 2) phase 2—once the LBT BW is known, the UE can perform RF retuning and decode the information over the intended activated BWP.

Systems and Implementations

FIG. 6 illustrates an example architecture of a system 600 of a network, in accordance with various embodiments. The following description is provided for an example system 600 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 6, the system 600 includes UE 601a and UE 601b (collectively referred to as “UEs 601” or “UE 601”). In this example, UEs 601 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 601 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some of these embodiments, the UEs 601 may be NB-IoT UEs 601. NB-IoT provides access to network services using physical layer optimized for very low power consumption (e.g., full carrier BW is 180 kHz, subcarrier spacing can be 3.75 kHz or 15 kHz). A number of E-UTRA functions are not used for NB-IoT and need not be supported by RAN nodes 611 and UEs 601 only using NB-IoT. Examples of such E-UTRA functions may include inter-RAT mobility, handover, measurement reports, public warning functions, GBR, CSG, support of HeNBs, relaying, carrier aggregation, dual connectivity, NAICS, MBMS, real-time services, interference avoidance for in-device coexistence, RAN assisted WLAN interworking, sidelink communication/discovery, MDT, emergency call, CS fallback, self-configuration/self-optimization, among others. For NB-IoT operation, a UE 601 operates in the DL using 12 sub-carriers with a sub-carrier BW of 15 kHz, and in the UL using a single sub-carrier with a sub-carrier BW of either 3.75 kHz or 15 kHz or alternatively 3, 6 or 12 sub-carriers with a sub-carrier BW of 15 kHz.

In various embodiments, the UEs 601 may be MF UEs 601. MF UEs 601 are LTE-based UEs 601 that operate (exclusively) in unlicensed spectrum. This unlicensed spectrum is defined in MF specifications provided by the MulteFire Forum, and may include, for example, 1.9 GHz (Japan), 3.5 GHz, and 5 GHz. MulteFire is tightly aligned with 3GPP standards and builds on elements of the 3GPP specifications for LAA/eLAA, augmenting standard LTE to operate in global unlicensed spectrum. In some embodiments, LBT may be implemented to coexist with other unlicensed spectrum networks, such as WiFi, other LAA networks, or the like. In various embodiments, some or all UEs 601 may be NB-IoT UEs 601 that operate according to MF. In such embodiments, these UEs 601 may be referred to as “MF NB-IoT UEs 601,” however, the term “NB-IoT UE 601” may refer to an “MF UE 601” or an “MF and NB-IoT UE 601” unless stated otherwise. Thus, the terms “NB-IoT UE 601,” “MF UE 601,” and “MF NB-IoT UE 601” may be used interchangeably throughout the present disclosure.

The UEs 601 may be configured to connect, for example, communicatively couple, with an or RAN 610. In embodiments, the RAN 610 may be an NG RAN or a 5G RAN, an E-UTRAN, an MF RAN, or a legacy RAN, such as a UTRAN or GERAN. As used herein, the term “NG RAN” or the like may refer to a RAN 610 that operates in an NR or 5G system 600, the term “E-UTRAN” or the like may refer to a RAN 610 that operates in an LTE or 4G system 600, and the term “MF RAN” or the like refers to a RAN 610 that operates in an MF system 100. The UEs 601 utilize connections (or channels) 603 and 604, respectively, each of which comprises a physical communications interface or layer (discussed in further detail below). The connections 103 and 104 may include several different physical DL channels and several different physical UL channels. As examples, the physical DL channels include the PDSCH, PMCH, PDCCH, EPDCCH, MPDCCH, R-PDCCH, SPDCCH, PBCH, PCFICH, PHICH, NPBCH, NPDCCH, NPDSCH, and/or any other physical DL channels mentioned herein. As examples, the physical UL channels include the PRACH, PUSCH, PUCCH, SPUCCH, NPRACH, NPUSCH, and/or any other physical UL channels mentioned herein.

In this example, the connections 603 and 604 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 601 may directly exchange communication data via a ProSe interface 605. The ProSe interface 605 may alternatively be referred to as a SL interface 605 and may comprise one or more physical and/or logical channels, including but not limited to the PSCCH, PSSCH, PSDCH, and PSBCH.

The UE 601b is shown to be configured to access an AP 606 (also referred to as “WLAN node 606,” “WLAN 606,” “WLAN Termination 606,” “WT 606” or the like) via connection 607. The connection 607 can comprise a local wireless connection, such as a connection consistent with any IEEE 802.11 protocol, wherein the AP 606 would comprise a wireless fidelity (Wi-Fi®) router. In this example, the AP 606 is shown to be connected to the Internet without connecting to the core network of the wireless system (described in further detail below). In various embodiments, the UE 601b, RAN 610, and AP 606 may be configured to utilize LWA operation and/or LWIP operation. The LWA operation may involve the UE 601b in RRC_CONNECTED being configured by a RAN node 611a-b to utilize radio resources of LTE and WLAN. LWIP operation may involve the UE 601b using WLAN radio resources (e.g., connection 607) via IPsec protocol tunneling to authenticate and encrypt packets (e.g., IP packets) sent over the connection 607. IPsec tunneling may include encapsulating the entirety of original IP packets and adding a new packet header, thereby protecting the original header of the IP packets.

The RAN 610 can include one or more AN nodes or RAN nodes 611a and 611b (collectively referred to as “RAN nodes 611” or “RAN node 611”) that enable the connections 603 and 604. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, MF-APs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 611 that operates in an NR or 5G system 600 (e.g., a gNB), and the term “E-UTRAN node” or the like may refer to a RAN node 611 that operates in an LTE or 4G system 600 (e.g., an eNB). According to various embodiments, the RAN nodes 611 may be implemented as one or more of a dedicated physical device such as a macrocell base station, and/or a low power (LP) base station for providing femtocells, picocells or other like cells having smaller coverage areas, smaller user capacity, or higher BW compared to macrocells.

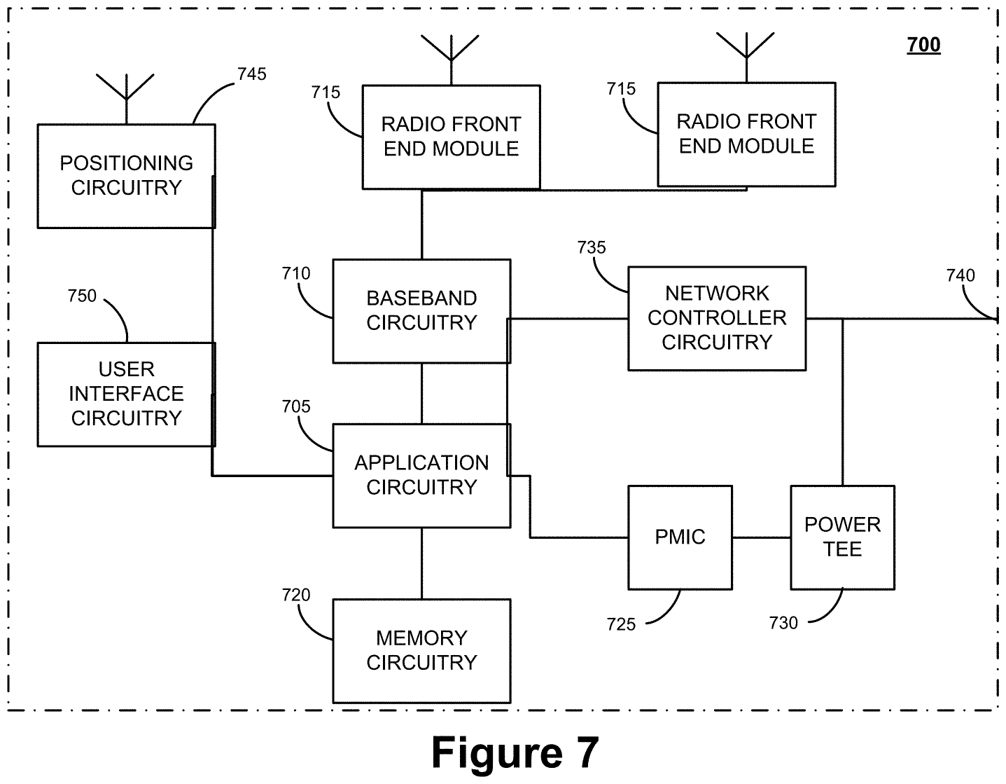

In some embodiments, all or parts of the RAN nodes 611 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 611; a MAC/PHY split wherein RRC, PDCP, RLC, and MAC layers are operated by the CRAN/vBBUP and the PHY layer is operated by individual RAN nodes 611; or a “lower PHY” split wherein RRC, PDCP, RLC, MAC layers and upper portions of the PHY layer are operated by the CRAN/vBBUP and lower portions of the PHY layer are operated by individual RAN nodes 611. This virtualized framework allows the freed-up processor cores of the RAN nodes 611 to perform other virtualized applications. In some implementations, an individual RAN node 611 may represent individual gNB-DUs that are connected to a gNB-CU via individual F1 interfaces (not shown by FIG. 6). In these implementations, the gNB-DUs may include one or more remote radio heads or RFEMs (see e.g., FIG. 7), and the gNB-CU may be operated by a server that is located in the RAN 610 (not shown) or by a server pool in a similar manner as the CRAN/vBBUP. Additionally or alternatively, one or more of the RAN nodes 611 may be next generation eNBs (ng-eNBs), which are RAN nodes that provide E-UTRA user plane and control plane protocol terminations toward the UEs 601, and are connected to a 5GC via an NG interface (discussed infra). In MF implementations, the MF-APs 611 are entities that provide MulteFire radio services, and may be similar to eNBs 611 in an 3GPP architecture. Each MF-AP 611 includes or provides one or more MF cells.

In V2X scenarios one or more of the RAN nodes 611 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 601 (vUEs 601). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 611 can terminate the air interface protocol and can be the first point of contact for the UEs 601. In some embodiments, any of the RAN nodes 611 can fulfill various logical functions for the RAN 610 including, but not limited to, radio network controller (RNC) functions such as radio bearer management, uplink and downlink dynamic radio resource management and data packet scheduling, and mobility management.

In embodiments, the UEs 601 can be configured to communicate using OFDM communication signals with each other or with any of the RAN nodes 611 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

Downlink and uplink transmissions may be organized into frames with 10 ms durations, where each frame includes ten 1 ms subframes. A slot duration is 14 symbols with Normal CP and 12 symbols with Extended CP, and scales in time as a function of the used sub-carrier spacing so that there is always an integer number of slots in a subframe. In LTE implementations, a DL resource grid can be used for DL transmissions from any of the RAN nodes 611 to the UEs 601, while UL transmissions from the UEs 601 to RAN nodes 611 can utilize a suitable UL resource grid in a similr manner. These resource grids may refer to time-frequency grids, and indicate physical resource in the DL or UL in each slot. Each column and each row of the DL resource grid corresponds to one OFDM symbol and one OFDM subcarrier, respectively, and each column and each row of the UL resource grid corresponds to one SC-FDMA symbol and one SC-FDMA subcarrier, respectively. The duration of the resource grid in the time domain corresponds to one slot in a radio frame. The resource grids comprises a number of RBs, which describe the mapping of certain physical channels to REs. In the frequency domain, this may represent the smallest quantity of resources that currently can be allocated. Each RB comprises a collection of REs. An RE is the smallest time-frequency unit in a resource grid. Each RE is uniquely identified by the index pair (k,l) in a slot where k=0, . . . , N_{RB}^{DL}N_{sc}^{RB}−1 and l=0, . . . , N_{symb}^{DL}−1 are the indices in the frequency and time domains, respectively. RE (k,l) on antenna port p corresponds to the complex value a_{k,l}^{(p)}. An antenna port is defined such that the channel over which a symbol on the antenna port is conveyed can be inferred from the channel over which another symbol on the same antenna port is conveyed. There is one resource grid per antenna port. The set of antenna ports supported depends on the reference signal configuration in the cell, and these aspects are discussed in more detail in 3GPP TS 36.211.

In NR/5G implementations, DL and UL transmissions are organized into frames with 10 ms durations each of which includes ten 1 ms subframes. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with a half-frame 0 comprising subframes 0-4 and a half-frame 1 comprising subframes 5-9. There is one set of frames in the UL and one set of frames in the DL on a carrier. Uplink frame number i for transmission from the UE 601 starts T_{TA}=(N_{TA}+N_{TA,offset})T_{c} before the start of the corresponding downlink frame at the UE where N_{TA,offset} is given by 3 GPP TS 38.213. For subcarrier spacing configuration μ, slots are numbered nₛ^{μ}∈ {0, . . . , Nₛₗₒₜ^{subframe,μ}−1} in increasing order within a subframe and n_{sf}^{μ}∈ {0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by tables 4.3.2-1 and 4.3.2-2 of 3GPP TS 38.211. The start of slot nₛ^{μ} in a subframe is aligned in time with the start of OFDM symbol nₛ^{μ}N_{symb}^{slot} in the same subframe. OFDM symbols in a slot can be classified as ‘downlink’, ‘flexible’, or ‘uplink’, where downlink transmissions only occur in ‘downlink’ or ‘flexible’ symbols and the UEs 601 only transmit in ‘uplink’ or ‘flexible’ symbols.

For each numerology and carrier, a resource grid of N_{grid,x}^{size,μ}N_{sc}^{RB} subcarriers and N_{symb}^{subframe,μ} OFDM symbols is defined, starting at common RB N_{grid}^{start,μ} indicated by higher-layer signaling. There is one set of resource grids per transmission direction (e.g., uplink or downlink) with the subscript x set to DL for downlink and x set to UL for uplink. There is one resource grid for a given antenna port p, subcarrier spacing configuration μ, and transmission direction (e.g., downlink or uplink).

An RB is defined as N_{sc}^{RB}=12 consecutive subcarriers in the frequency domain. Common RBs are numbered from 0 and upwards in the frequency domain for subcarrier spacing configuration μ. The center of subcarrier 0 of common resource block 0 for subcarrier spacing configuration μ coincides with ‘point A’. The relation between the common resource block number n_{CRB}^{μ}in the frequency domain and resource elements (k,l) for subcarrier spacing configuration μ is given by

$${n}_{C R B}^{μ} = ⌊ \frac{k}{{N}_{s c}^{R B}} ⌋$$

where k is defined relative to point A such that k=0 corresponds to the subcarrier centered around point A. Point A serves as a common reference point for resource block grids and is obtained from offsetToPointA for a PCell downlink where offsetToPointA represents the frequency offset between point A and the lowest subcarrier of the lowest resource block, which has the subcarrier spacing provided by the higher-layer parameter subCarrierSpacingCommon and overlaps with the SS/PBCH block used by the UE for initial cell selection, expressed in units of resource blocks assuming 15 kHz subcarrier spacing for FR1 and 60 kHz subcarrier spacing for FR2; and absoluteFrequencyPointA for all other cases where absoluteFrequencyPointA represents the frequency-location of point A expressed as in ARFCN.

A PRB for subcarrier configuration μ are defined within a BWP and numbered from 0 to N_{BWP}^{size,μ}−1 where i is the number of the BWP. The relation between the physical resource block n_{PRB}^{μ} in BWPi and the common RB n_{CRB}^{μ} is given by n_{CRB}^{μ}=n_{PRB}^{μ}+N_{BWP,i}^{start,μ} where N_{BWP,i}^{start,μ} is the common RB where BWP starts relative to common RB 0. VRBs are defined within a BWP and numbered from 0 to N_{BWP,i}^{size,μ}−1 where i is the number of the BWP.

Each element in the resource grid for antenna port p and subcarrier spacing configuration μ is called an RE and is uniquely identified by (k, l)_{p,μ} where k is the index in the frequency domain and 1 refers to the symbol position in the time domain relative to some reference point. Resource element (k, l)_{p,μ} corresponds to a physical resource and the complex value a_{k,l}^{(p,μ)}. An antenna port is defined such that the channel over which a symbol on the antenna port is conveyed can be inferred from the channel over which another symbol on the same antenna port is conveyed. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

A BWP is a subset of contiguous common resource blocks defined in subclause 4.4.4.3 of 3GPP TS 38.211 for a given numerology μᵢ in BWPⁱ on a given carrier. The starting position N_{BWP,i}^{start,μ} and the number of resource blocks N_{BWP,i}^{size,μ} in a BWP shall fulfil N_{grid,x}^{start,μ}≤N_{BWP,i}^{start,μ}<N_{grid,x}^{start,μ}+N_{grid,x}^{size,μ} and N_{grid,x}^{start,μ}<N_{BWP,i}^{start,μ}+N_{BWP,i}^{size,μ}≤N_{grid,x}^{start,μ}+N_{grid,x}^{size,μ} respectively. Configuration of a BWP is described in clause 12 of 3GPP TS 38.213. The UEs 601 can be configured with up to four BWPs in the DL with a single DL BWP being active at a given time. The UEs 601 are not expected to receive PDSCH, PDCCH, or CSI-RS (except for RRM) outside an active BWP. The UEs 601 can be configured with up to four BWPs in the UL with a single UL BWP being active at a given time. If a UE 601 is configured with a supplementary UL, the UE 601 can be configured with up to four additional BWPs in the supplementary UL with a single supplementary UL BWP being active at a given time. The UEs 601 do not transmit PUSCH or PUCCH outside an active BWP, and for an active cell, the UEs do not transmit SRS outside an active BWP.

An NB is defined as six non-overlapping consecutive PRBs in the frequency domain. The total number of DL NBs in the DL transmission BW configured in the cell is given by

$${N}_{N B}^{D L} = ⌊ \frac{{N}_{R B}^{D L}}{6} ⌋ .$$

The NBs are numbered n_{NB}=0, . . . , N_{NB}^{DL}−1 in order of increasing PRB number where narrowband n_{NB} is comprises PRB indices:

$$\{ \begin{matrix}6 {n}_{N B} + {i}_{0} + i & if {N}_{R B}^{U L} mod 2 = 0 \\ 6 {n}_{N B} + {i}_{0} + i & if {N}_{R B}^{U L} mod 2 = 1 and {n}_{N B} < {N}_{N B}^{U L} / 2 \\ 6 {n}_{N B} + {i}_{0} + i + 1 & if {N}_{R B}^{U L} mod 2 = 1 and {n}_{N B} \geq {N}_{N B}^{U L} / 2\end{matrix} ,$$

where i=0,1, . . . , 5

$${i}_{0} = ⌊ \frac{{N}_{R B}^{U L}}{2} ⌋ - \frac{6 {N}_{N B}^{U L}}{2} .$$

If N_{NB}^{UL}≥4, a wideband is defined as four non-overlapping narrowbands in the frequency domain. The total number of uplink widebands in the uplink transmission bandwidth configured in the cell is given by

$${N}_{W B}^{U L} = ⌊ \frac{{N}_{N B}^{U L}}{4} ⌋$$

and the widebands are numbered n_{WB}=0, . . . , N_{WB}^{UL}−1 in order of increasing narrowband number where wideband n_{WB} is composed of narrowband indices 4n_{WB}+i where i=0,1, . . . , 3. If N_{NB}^{UL}<4, then N_{WB}^{UL}−1 and the single wideband is composed of the N_{NB}^{UL} non-overlapping narrowband(s).

There are several different physical channels and physical signals that are conveyed using RBs and/or individual REs. A physical channel corresponds to a set of REs carrying information originating from higher layers. Physical UL channels may include PUSCH, PUCCH, PRACH, and/or any other physical UL channel(s) discussed herein, and physical DL channels may include PDSCH, PBCH, PDCCH, and/or any other physical DL channel(s) discussed herein. A physical signal is used by the physical layer but does not carry information originating from higher layers. Physical UL signals may include DMRS, PTRS, SRS, and/or any other physical UL signal(s) discussed herein, and physical DL signals may include DMRS, PTRS, CSI-RS, PSS, SSS, and/or any other physical DL signal(s) discussed herein.

The PDSCH carries user data and higher-layer signaling to the UEs 601. Typically, DL scheduling (assigning control and shared channel resource blocks to the UE 601 within a cell) may be performed at any of the RAN nodes 611 based on channel quality information fed back from any of the UEs 601. The downlink resource assignment information may be sent on the PDCCH used for (e.g., assigned to) each of the UEs 601. The PDCCH uses CCEs to convey control information (e.g., DCI), and a set of CCEs may be referred to a “control region.” Control channels are formed by aggregation of one or more CCEs, where different code rates for the control channels are realized by aggregating different numbers of CCEs. The CCEs are numbered from 0 to N_{CCE,k}−1, where N_{CCE,k}−1 is the number of CCEs in the control region of subframe k. Before being mapped to REs, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical REs known as REGs. Four QPSK symbols may be mapped to each REG. The PDCCH can be transmitted using one or more CCEs, depending on the size of the DCI and the channel condition. There can be four or more different PDCCH formats defined with different numbers of CCEs (e.g., aggregation level, L=1, 2, 4, or 8 in LTE and L=1, 2, 4, 8, or 16 in NR). The UE 601 monitors a set of PDCCH candidates on one or more activated serving cells as configured by higher layer signaling for control information (e.g., DCI), where monitoring implies attempting to decode each of the PDCCHs (or PDCCH candidates) in the set according to all the monitored DCI formats (e.g., DCI formats 0 through 6-2 as discussed in section 5.3.3 of 3GPP TS 38.212, DCI formats 0_0 through 2_3 as discussed in section 7.3 of 3GPP TS 38.212, or the like). The UEs 601 monitor (or attempt to decode) respective sets of PDCCH candidates in one or more configured monitoring occasions according to the corresponding search space configurations. A DCI transports DL, UL, or SL scheduling information, requests for aperiodic CQI reports, LAA common information, notifications of MCCH change, UL power control commands for one cell and/or one RNTI, notification of a group of UEs 601 of a slot format, notification of a group of UEs of the PRB(s) and OFDM symbol(s) where UE may assume no transmission is intended for the UE, TPC commands for PUCCH and PUSCH, and/or TPC commands for PUCCH and PUSCH. The DCI coding steps are discussed in 3GPP TS 38.212.

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

As alluded to previously, the PDCCH can be used to schedule DL transmissions on PDSCH and UL transmissions on PUSCH, wherein the DCI on PDCCH includes, inter alia, downlink assignments containing at least modulation and coding format, resource allocation, and HARQ information related to DL-SCH; and/or uplink scheduling grants containing at least modulation and coding format, resource allocation, and HARQ information related to UL-SCH. In addition to scheduling, the PDCCH can be used to for activation and deactivation of configured PUSCH transmission(s) with configured grant; activation and deactivation of PDSCH semi-persistent transmission; notifying one or more UEs 601 of a slot format; notifying one or more UEs 601 of the PRB(s) and OFDM symbol(s) where a UE 601 may assume no transmission is intended for the UE; transmission of TPC commands for PUCCH and PUSCH; transmission of one or more TPC commands for SRS transmissions by one or more UEs 601; switching an active BWP for a UE 601; and initiating a random access procedure.

In NR implementations, the UEs 601 monitor (or attempt to decode) respective sets of PDCCH candidates in one or more configured monitoring occasions in one or more configured CORESETs according to the corresponding search space configurations. A CORESET may include a set of PRBs with a time duration of 1 to 3 OFDM symbols. A CORESET may additionally or alternatively include N_{RB}^{CORESET} RBs in the frequency domain and N_{symb}^{CORESET} ∈{1,2,3} symbols in the time domain. A CORESET includes six REGs numbered in increasing order in a time-first manner, wherein an REG equals one RB during one OFDM symbol. The UEs 601 can be configured with multiple CORESETS where each CORESET is associated with one CCE-to-REG mapping only. Interleaved and non-interleaved CCE-to-REG mapping are supported in a CORESET. Each REG carrying a PDCCH carries its own DMRS.

According to various embodiments, the UEs 601 and the RAN nodes 611 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 601 and the RAN nodes 611 may operate using LAA, eLAA, and/or feLAA mechanisms. In these implementations, the UEs 601 and the RAN nodes 611 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 601 RAN nodes 611, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 601, AP 606, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the BWs of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 601 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The RAN nodes 611 may be configured to communicate with one another via interface 612. In embodiments where the system 600 is an LTE system (e.g., when CN 620 is an EPC), the interface 612 may be an X2 interface 612. The X2 interface may be defined between two or more RAN nodes 611 (e.g., two or more eNBs and the like) that connect to EPC 620, and/or between two eNBs connecting to EPC 620. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 601 from an SeNB for user data; information of PDCP PDUs that were not delivered to a UE 601; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality. In embodiments where the system 100 is an MF system (e.g., when CN 620 is an NHCN 620), the interface 612 may be an X2 interface 612. The X2 interface may be defined between two or more RAN nodes 611 (e.g., two or more MF-APs and the like) that connect to NHCN 620, and/or between two MF-APs connecting to NHCN 620. In these embodiments, the X2 interface may operate in a same or similar manner as discussed previously.

In embodiments where the system 600 is a 5G or NR system (e.g., when CN 620 is an 5GC), the interface 612 may be an Xn interface 612. The Xn interface is defined between two or more RAN nodes 611 (e.g., two or more gNBs and the like) that connect to 5GC 620, between a RAN node 611 (e.g., a gNB) connecting to 5GC 620 and an eNB, and/or between two eNBs connecting to 5GC 620. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 601 in a connected mode (e.g., CM-CONNECTED) including functionality to manage the UE mobility for connected mode between one or more RAN nodes 611. The mobility support may include context transfer from an old (source) serving RAN node 611 to new (target) serving RAN node 611; and control of user plane tunnels between old (source) serving RAN node 611 to new (target) serving RAN node 611. A protocol stack of the Xn-U may include a transport network layer built on Internet Protocol (IP) transport layer, and a GTP—U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 610 is shown to be communicatively coupled to a core network—in this embodiment, CN 620. The CN 620 may comprise a plurality of network elements 622, which are configured to offer various data and telecommunications services to customers/subscribers (e.g., users of UEs 601) who are connected to the CN 620 via the RAN 610. The components of the CN 620 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 620 may be referred to as a network slice, and a logical instantiation of a portion of the CN 620 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 630 may be an element offering applications that use IP bearer resources with the core network (e.g., UMTS PS domain, LTE PS data services, etc.). The application server 630 can also be configured to support one or more communication services (e.g., VoIP sessions, PTT sessions, group communication sessions, social networking services, etc.) for the UEs 601 via the EPC 620.

In embodiments, the CN 620 may be a 5GC (referred to as “5GC 620” or the like), and the RAN 610 may be connected with the CN 620 via an NG interface 613. In embodiments, the NG interface 613 may be split into two parts, an NG user plane (NG-U) interface 614, which carries traffic data between the RAN nodes 611 and a UPF, and the S1 control plane (NG-C) interface 615, which is a signaling interface between the RAN nodes 611 and AMFs.

In embodiments, the CN 620 may be a 5G CN (referred to as “5GC 620” or the like), while in other embodiments, the CN 620 may be an EPC). Where CN 620 is an EPC (referred to as “EPC 620” or the like), the RAN 610 may be connected with the CN 620 via an S1 interface 613. In embodiments, the S1 interface 613 may be split into two parts, an S1 user plane (S1-U) interface 614, which carries traffic data between the RAN nodes 611 and the S-GW, and the S1-MME interface 615, which is a signaling interface between the RAN nodes 611 and MMES.

In embodiments where the CN 620 is an MF NHCN 620, the one or more network elements 622 may include or operate one or more NH-MMES, local AAA proxies, NH-GWs, and/or other like MF NHCN elements. The NH-MME provides similar functionality as an MME in EPC 620. A local AAA proxy is an AAA proxy that is part of an NHN that provides AAA functionalities required for interworking with PSP AAA and 3GPP AAAs. A PSP AAA is an AAA server (or pool of servers) using non-USIM credentials that is associated with a PSP, and may be either internal or external to the NHN, and the 3GPP AAA is discussed in more detail in 3GPP TS 23.402. The NH-GW provides similar functionality as a combined S-GW/P-GW for non-EPC routed PDN connections. For EPC Routed PDN connections, the NHN-GW provides similar functionality as the S-GW discussed previously in interactions with the MF-APs over the S1 interface 613 and is similar to the TWAG in interactions with the PLMN PDN-GWs over the S2a interface. In some embodiments, the MF APs 611 may connect with the EPC 620 discussed previously. Additionally, the RAN 610 (referred to as an “MF RAN 610” or the like) may be connected with the NHCN 620 via an S1 interface 613. In these embodiments, the S1 interface 613 may be split into two parts, the S1-U interface 614 that carries traffic data between the RAN nodes 611 (e.g., the “MF-APs 611”) and the NH-GW, and the S1-MME-N interface 615, which is a signaling interface between the RAN nodes 611 and NH-MMEs. The S1-U interface 614 and the S1-MME-N interface 615 have the same or similar functionality as the S1-U interface 614 and the S1-MME interface 615 of the EPC 620 discussed herein.

FIG. 7 illustrates an example of infrastructure equipment 700 in accordance with various embodiments. The infrastructure equipment 700 (or “system 700”) may be implemented as a base station, radio head, RAN node such as the RAN nodes 611 and/or AP 606 shown and described previously, application server(s) 630, and/or any other element/device discussed herein. In other examples, the system 700 could be implemented in or by a UE.

The system 700 includes application circuitry 705, baseband circuitry 710, one or more radio front end modules (RFEMs) 715, memory circuitry 720, power management integrated circuitry (PMIC) 725, power tee circuitry 730, network controller circuitry 735, network interface connector 740, satellite positioning circuitry 745, and user interface 750. In some embodiments, the device 700 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 705 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 705 may be coupled with or may include memory/storage elements and may be configured to execute instructions stored in the memory/storage to enable various applications or operating systems to run on the system 700. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 705 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 705 may comprise, or may be, a special-purpose processor/controller to operate according to the various embodiments herein. As examples, the processor(s) of application circuitry 705 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 700 may not utilize application circuitry 705, and instead may include a special-purpose processor/controller to process IP data received from an EPC or SGC, for example.

In some implementations, the application circuitry 705 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 705 may comprise logic blocks or logic fabric, and other interconnected resources that may be programmed to perform various functions, such as the procedures, methods, functions, etc. of the various embodiments discussed herein. In such embodiments, the circuitry of application circuitry 705 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

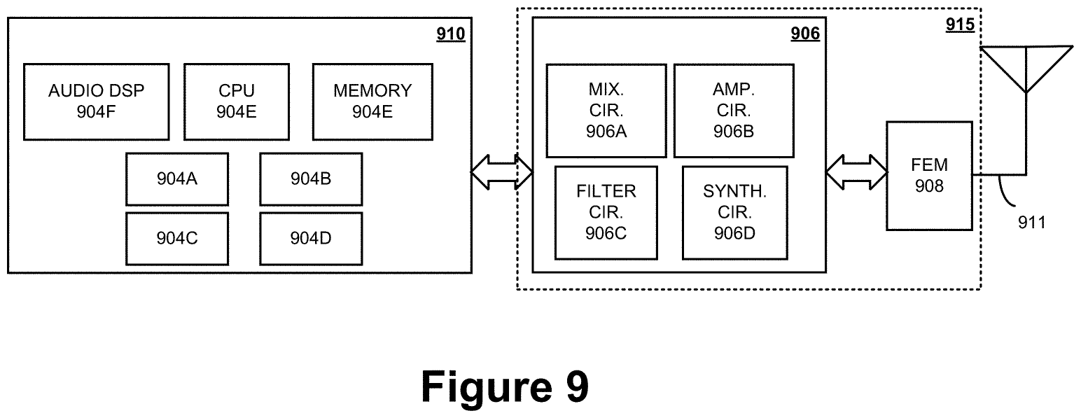

The baseband circuitry 710 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 710 are discussed infra with regard to FIG. 9.

User interface circuitry 750 may include one or more user interfaces designed to enable user interaction with the system 700 or peripheral component interfaces designed to enable peripheral component interaction with the system 700. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 715 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 911 of FIG. 9 infra), and the RFEM may be connected to multiple antennas. In alternative implementations, both mmWave and sub-mmWave radio functions may be implemented in the same physical RFEM 715, which incorporates both mmWave antennas and sub-mmWave.

The memory circuitry 720 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 720 may be implemented as one or more of solder down packaged integrated circuits, socketed memory modules and plug-in memory cards.

The PMIC 725 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 730 may provide for electrical power drawn from a network cable to provide both power supply and data connectivity to the infrastructure equipment 700 using a single cable.

The network controller circuitry 735 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 700 via network interface connector 740 using a physical connection, which may be electrical (commonly referred to as a “copper interconnect”), optical, or wireless. The network controller circuitry 735 may include one or more dedicated processors and/or FPGAs to communicate using one or more of the aforementioned protocols. In some implementations, the network controller circuitry 735 may include multiple controllers to provide connectivity to other networks using the same or different protocols.

The positioning circuitry 745 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 745 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 745 may include a Micro-Technology for Positioning, Navigation, and Timing (Micro-PNT) IC that uses a master timing clock to perform position tracking/estimation without GNSS assistance. The positioning circuitry 745 may also be part of, or interact with, the baseband circuitry 710 and/or RFEMs 715 to communicate with the nodes and components of the positioning network. The positioning circuitry 745 may also provide position data and/or time data to the application circuitry 705, which may use the data to synchronize operations with various infrastructure (e.g., RAN nodes 611, etc.), or the like.

The components shown by FIG. 7 may communicate with one another using interface circuitry, which may include any number of bus and/or interconnect (IX) technologies such as ISA, extended ISA, I2C, SPI, point-to-point interfaces, power management bus (PMBus), PCI, PCIe, PCIx, Intel® UPI, Intel® IAL, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, and/or any number of other IX technologies. The IX technology may be a proprietary bus, for example, used in an SoC based system.

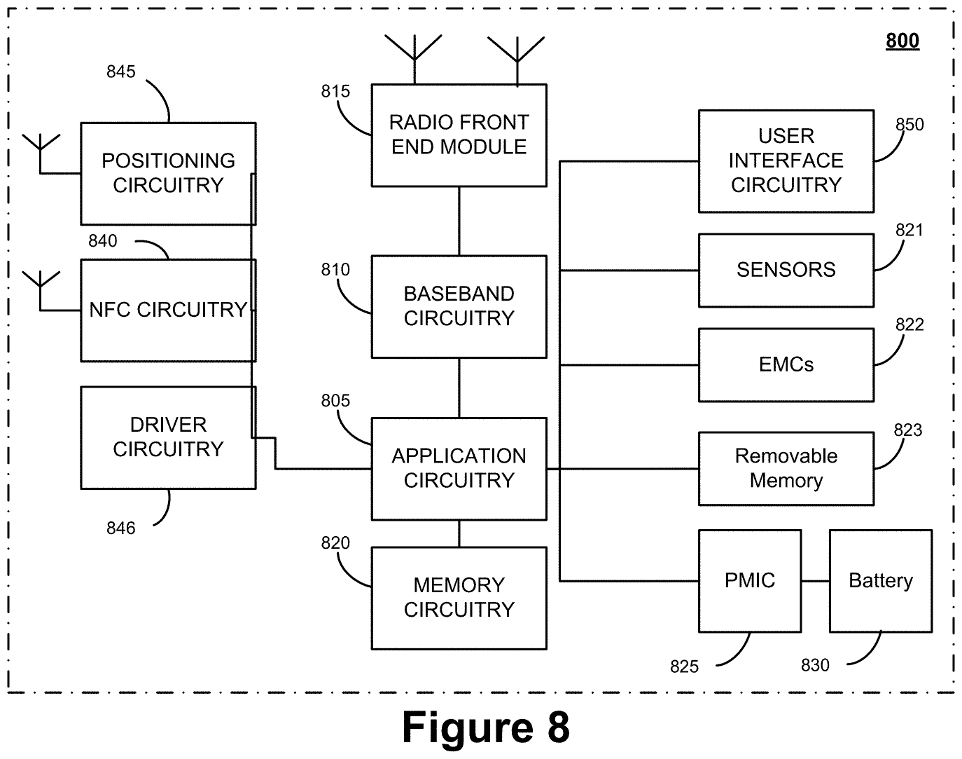

FIG. 8 illustrates an example of a platform 800 (or “device 800”) in accordance with various embodiments. In embodiments, the computer platform 800 may be suitable for use as UEs 601, application servers 630, and/or any other element/device discussed herein. The platform 800 may include any combinations of the components shown in the example. The components of platform 800 may be implemented as integrated circuits (ICs), portions thereof, discrete electronic devices, or other modules, logic, hardware, software, firmware, or a combination thereof adapted in the computer platform 800, or as components otherwise incorporated within a chassis of a larger system. The block diagram of FIG. 8 is intended to show a high level view of components of the computer platform 800. However, some of the components shown may be omitted, additional components may be present, and different arrangement of the components shown may occur in other implementations.

Application circuitry 805 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 805 may be coupled with or may include memory/storage elements and may be configured to execute instructions stored in the memory/storage to enable various applications or operating systems to run on the system 800. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 705 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 705 may comprise, or may be, a special-purpose processor/controller to operate according to the various embodiments herein.

As examples, the processor(s) of application circuitry 805 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 805 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 805 may be a part of a system on a chip (SoC) in which the application circuitry 805 and other components are formed into a single integrated circuit, or a single package, such as the Edison™ or Galileo™ SoC boards from Intel® Corporation.

Additionally or alternatively, application circuitry 805 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 805 may comprise logic blocks or logic fabric, and other interconnected resources that may be programmed to perform various functions, such as the procedures, methods, functions, etc. of the various embodiments discussed herein. In such embodiments, the circuitry of application circuitry 805 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 810 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 810 are discussed infra with regard to FIG. 9.

The RFEMs 815 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 911 of FIG. 9 infra), and the RFEM may be connected to multiple antennas. In alternative implementations, both mmWave and sub-mmWave radio functions may be implemented in the same physical RFEM 815, which incorporates both mmWave antennas and sub-mmWave.

The memory circuitry 820 may include any number and type of memory devices used to provide for a given amount of system memory. As examples, the memory circuitry 820 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 820 may be developed in accordance with a Joint Electron Devices Engineering Council (JEDEC) low power double data rate (LPDDR)-based design, such as LPDDR2, LPDDR3, LPDDR4, or the like. Memory circuitry 820 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 820 may be on-die memory or registers associated with the application circuitry 805. To provide for persistent storage of information such as data, applications, operating systems and so forth, memory circuitry 820 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 800 may incorporate the three-dimensional (3D) cross-point (XPOINT) memories from Intel® and Micron®.

Removable memory circuitry 823 may include devices, circuitry, enclosures/housings, ports or receptacles, etc. used to couple portable data storage devices with the platform 800. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 800 may also include interface circuitry (not shown) that is used to connect external devices with the platform 800. The external devices connected to the platform 800 via the interface circuitry include sensor circuitry 821 and electro-mechanical components (EMCs) 822, as well as removable memory devices coupled to removable memory circuitry 823.

The sensor circuitry 821 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 822 include devices, modules, or subsystems whose purpose is to enable platform 800 to change its state, position, and/or orientation, or move or control a mechanism or (sub)system. Additionally, EMCs 822 may be configured to generate and send messages/signalling to other components of the platform 800 to indicate a current state of the EMCs 822. Examples of the EMCs 822 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 800 is configured to operate one or more EMCs 822 based on one or more captured events and/or instructions or control signals received from a service provider and/or various clients.

In some implementations, the interface circuitry may connect the platform 800 with positioning circuitry 845. The positioning circuitry 845 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 845 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 845 may include a Micro-PNT IC that uses a master timing clock to perform position tracking/estimation without GNSS assistance. The positioning circuitry 845 may also be part of, or interact with, the baseband circuitry 710 and/or RFEMs 815 to communicate with the nodes and components of the positioning network. The positioning circuitry 845 may also provide position data and/or time data to the application circuitry 805, which may use the data to synchronize operations with various infrastructure (e.g., radio base stations), for turn-by-turn navigation applications, or the like

In some implementations, the interface circuitry may connect the platform 800 with Near-Field Communication (NFC) circuitry 840. NFC circuitry 840 is configured to provide contactless, short-range communications based on radio frequency identification (RFID) standards, wherein magnetic field induction is used to enable communication between NFC circuitry 840 and NFC-enabled devices external to the platform 800 (e.g., an “NFC touchpoint”). NFC circuitry 840 comprises an NFC controller coupled with an antenna element and a processor coupled with the NFC controller. The NFC controller may be a chip/IC providing NFC functionalities to the NFC circuitry 840 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 840, or initiate data transfer between the NFC circuitry 840 and another active NFC device (e.g., a smartphone or an NFC-enabled POS terminal) that is proximate to the platform 800.

The driver circuitry 846 may include software and hardware elements that operate to control particular devices that are embedded in the platform 800, attached to the platform 800, or otherwise communicatively coupled with the platform 800. The driver circuitry 846 may include individual drivers allowing other components of the platform 800 to interact with or control various input/output (I/O) devices that may be present within, or connected to, the platform 800. For example, driver circuitry 846 may include a display driver to control and allow access to a display device, a touchscreen driver to control and allow access to a touchscreen interface of the platform 800, sensor drivers to obtain sensor readings of sensor circuitry 821 and control and allow access to sensor circuitry 821, EMC drivers to obtain actuator positions of the EMCs 822 and/or control and allow access to the EMCs 822, a camera driver to control and allow access to an embedded image capture device, audio drivers to control and allow access to one or more audio devices.

The power management integrated circuitry (PMIC) 825 (also referred to as “power management circuitry 825”) may manage power provided to various components of the platform 800. In particular, with respect to the baseband circuitry 810, the PMIC 825 may control power-source selection, voltage scaling, battery charging, or DC-to-DC conversion. The PMIC 825 may often be included when the platform 800 is capable of being powered by a battery 830, for example, when the device is included in a UE 601.

In some embodiments, the PMIC 825 may control, or otherwise be part of, various power saving mechanisms of the platform 800. For example, if the platform 800 is in an RRC_Connected state, where it is still connected to the RAN node as it expects to receive traffic shortly, then it may enter a state known as Discontinuous Reception Mode (DRX) after a period of inactivity. During this state, the platform 800 may power down for brief intervals of time and thus save power. If there is no data traffic activity for an extended period of time, then the platform 800 may transition off to an RRC Idle state, where it disconnects from the network and does not perform operations such as channel quality feedback, handover, etc. The platform 800 goes into a very low power state and it performs paging where again it periodically wakes up to listen to the network and then powers down again. The platform 800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 830 may power the platform 800, although in some examples the platform 800 may be mounted deployed in a fixed location, and may have a power supply coupled to an electrical grid. The battery 830 may be a lithium ion battery, a metal-air battery, such as a zinc-air battery, an aluminum-air battery, a lithium-air battery, and the like. In some implementations, such as in V2X applications, the battery 830 may be a typical lead-acid automotive battery.

In some implementations, the battery 830 may be a “smart battery,” which includes or is coupled with a Battery Management System (BMS) or battery monitoring integrated circuitry. The BMS may be included in the platform 800 to track the state of charge (SoCh) of the battery 830. The BMS may be used to monitor other parameters of the battery 830 to provide failure predictions, such as the state of health (SoH) and the state of function (SoF) of the battery 830. The BMS may communicate the information of the battery 830 to the application circuitry 805 or other components of the platform 800. The BMS may also include an analog-to-digital (ADC) convertor that allows the application circuitry 805 to directly monitor the voltage of the battery 830 or the current flow from the battery 830. The battery parameters may be used to determine actions that the platform 800 may perform, such as transmission frequency, network operation, sensing frequency, and the like.

A power block, or other power supply coupled to an electrical grid may be coupled with the BMS to charge the battery 830. In some examples, the power block XS30 may be replaced with a wireless power receiver to obtain the power wirelessly, for example, through a loop antenna in the computer platform 800. In these examples, a wireless battery charging circuit may be included in the BMS. The specific charging circuits chosen may depend on the size of the battery 830, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 850 includes various input/output (I/O) devices present within, or connected to, the platform 800, and includes one or more user interfaces designed to enable user interaction with the platform 800 and/or peripheral component interfaces designed to enable peripheral component interaction with the platform 800. The user interface circuitry 850 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 800. The output device circuitry may also include speakers or other audio emitting devices, printer(s), and/or the like. In some embodiments, the sensor circuitry 821 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 800 may communicate with one another using a suitable bus or interconnect (IX) technology, which may include any number of technologies, including ISA, extended ISA, I²C, SPI, point-to-point interfaces, power management bus (PMBus), PCI, PCIe, PCIx, Intel® UPI, Intel® IAL, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. The IX technology may be a proprietary bus, for example, used in an SoC based system.

FIG. 9 illustrates example components of baseband circuitry 910 and radio front end modules (RFEM) 915 in accordance with various embodiments. The baseband circuitry 910 corresponds to the baseband circuitry 710 and 810 of FIGS. 7 and 8, respectively. The RFEM 915 corresponds to the RFEM 715 and 815 of FIGS. 7 and 8, respectively. As shown, the RFEMs 915 may include Radio Frequency (RF) circuitry 906, front-end module (FEM) circuitry 908, antenna array 911 coupled together at least as shown.

The baseband circuitry 910 includes circuitry and/or control logic configured to carry out various radio/network protocol and radio control functions that enable communication with one or more radio networks via the RF circuitry 906. The radio control functions may include, but are not limited to, signal modulation/demodulation, encoding/decoding, radio frequency shifting, etc. In some embodiments, modulation/demodulation circuitry of the baseband circuitry 910 may include Fast-Fourier Transform (FFT), precoding, or constellation mapping/demapping functionality. In some embodiments, encoding/decoding circuitry of the baseband circuitry 910 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 910 is configured to process baseband signals received from a receive signal path of the RF circuitry 906 and to generate baseband signals for a transmit signal path of the RF circuitry 906. The baseband circuitry 910 is configured to interface with application circuitry 705/805 (see FIGS. 7 and 8) for generation and processing of the baseband signals and for controlling operations of the RF circuitry 906. The baseband circuitry 910 may handle various radio control functions.

The aforementioned circuitry and/or control logic of the baseband circuitry 910 may include one or more single or multi-core processors. For example, the one or more processors may include a 3G baseband processor 904A, a 4G/LTE baseband processor 904B, a 5G/NR baseband processor 904C, or some other baseband processor(s) 904D for other existing generations, generations in development or to be developed in the future (e.g., sixth generation (6G), etc.). In other embodiments, some or all of the functionality of baseband processors 904A-D may be included in modules stored in the memory 904G and executed via a Central Processing Unit (CPU) 904E. In other embodiments, some or all of the functionality of baseband processors 904A-D may be provided as hardware accelerators (e.g., FPGAs, ASICs, etc.) loaded with the appropriate bit streams or logic blocks stored in respective memory cells. In various embodiments, the memory 904G may store program code of a real-time OS (RTOS), which when executed by the CPU 904E (or other baseband processor), is to cause the CPU 904E (or other baseband processor) to manage resources of the baseband circuitry 910, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 910 includes one or more audio digital signal processor(s) (DSP) 904F. The audio DSP(s) 904F include elements for compression/decompression and echo cancellation and may include other suitable processing elements in other embodiments.

In some embodiments, each of the processors 904A-904E include respective memory interfaces to send/receive data to/from the memory 904G. The baseband circuitry 910 may further include one or more interfaces to communicatively couple to other circuitries/devices, such as an interface to send/receive data to/from memory external to the baseband circuitry 910; an application circuitry interface to send/receive data to/from the application circuitry 705/805 of FIGS. 7-9); an RF circuitry interface to send/receive data to/from RF circuitry 906 of FIG. 9; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 825.

In alternate embodiments (which may be combined with the above described embodiments), baseband circuitry 910 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 910 may include protocol processing circuitry with one or more instances of control circuitry (not shown) to provide control functions for the digital baseband circuitry and/or radio frequency circuitry (e.g., the radio front end modules 915).

Although not shown by FIG. 9, in some embodiments, the baseband circuitry 910 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 910 and/or RF circuitry 906 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 910 and/or RF circuitry 906 are part of a Wi-Fi communication system. In the second example, the protocol processing circuitry would operate Wi-Fi MAC and logical link control (LLC) functions. The protocol processing circuitry may include one or more memory structures (e.g., 904G) to store program code and data for operating the protocol functions, as well as one or more processing cores to execute the program code and perform various operations using the data. The baseband circuitry 910 may also support radio communications for more than one wireless protocol.

The various hardware elements of the baseband circuitry 910 discussed herein may be implemented, for example, as a solder-down substrate including one or more integrated circuits (ICs), a single packaged IC soldered to a main circuit board or a multi-chip module containing two or more ICs. In one example, the components of the baseband circuitry 910 may be suitably combined in a single chip or chipset, or disposed on a same circuit board. In another example, some or all of the constituent components of the baseband circuitry 910 and RF circuitry 906 may be implemented together such as, for example, a system on a chip (SoC) or System-in-Package (SiP). In another example, some or all of the constituent components of the baseband circuitry 910 may be implemented as a separate SoC that is communicatively coupled with and RF circuitry 906 (or multiple instances of RF circuitry 906). In yet another example, some or all of the constituent components of the baseband circuitry 910 and the application circuitry 705/805 may be implemented together as individual SoCs mounted to a same circuit board (e.g., a “multi-chip package”).

In some embodiments, the baseband circuitry 910 may provide for communication compatible with one or more radio technologies. For example, in some embodiments, the baseband circuitry 910 may support communication with an E-UTRAN or other WMAN, a WLAN, a WPAN. Embodiments in which the baseband circuitry 910 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc. to facilitate the communication with the wireless network. RF circuitry 906 may include a receive signal path, which may include circuitry to down-convert RF signals received from the FEM circuitry 908 and provide baseband signals to the baseband circuitry 910. RF circuitry 906 may also include a transmit signal path, which may include circuitry to up-convert baseband signals provided by the baseband circuitry 910 and provide RF output signals to the FEM circuitry 908 for transmission.

In some embodiments, the receive signal path of the RF circuitry 906 may include mixer circuitry 906a, amplifier circuitry 906b and filter circuitry 906c. In some embodiments, the transmit signal path of the RF circuitry 906 may include filter circuitry 906c and mixer circuitry 906a. RF circuitry 906 may also include synthesizer circuitry 906d for synthesizing a frequency for use by the mixer circuitry 906a of the receive signal path and the transmit signal path. In some embodiments, the mixer circuitry 906a of the receive signal path may be configured to down-convert RF signals received from the FEM circuitry 908 based on the synthesized frequency provided by synthesizer circuitry 906d. The amplifier circuitry 906b may be configured to amplify the down-converted signals and the filter circuitry 906c may be a low-pass filter (LPF) or band-pass filter (BPF) configured to remove unwanted signals from the down-converted signals to generate output baseband signals. Output baseband signals may be provided to the baseband circuitry 910 for further processing. In some embodiments, the output baseband signals may be zero-frequency baseband signals, although this is not a requirement. In some embodiments, mixer circuitry 906a of the receive signal path may comprise passive mixers, although the scope of the embodiments is not limited in this respect.

In some embodiments, the mixer circuitry 906a of the transmit signal path may be configured to up-convert input baseband signals based on the synthesized frequency provided by the synthesizer circuitry 906d to generate RF output signals for the FEM circuitry 908. The baseband signals may be provided by the baseband circuitry 910 and may be filtered by filter circuitry 906c.

In some embodiments, the mixer circuitry 906a of the receive signal path and the mixer circuitry 906a of the transmit signal path may include two or more mixers and may be arranged for quadrature downconversion and upconversion, respectively. In some embodiments, the mixer circuitry 906a of the receive signal path and the mixer circuitry 906a of the transmit signal path may include two or more mixers and may be arranged for image rejection (e.g., Hartley image rejection). In some embodiments, the mixer circuitry 906a of the receive signal path and the mixer circuitry 906a of the transmit signal path may be arranged for direct downconversion and direct upconversion, respectively. In some embodiments, the mixer circuitry 906a of the receive signal path and the mixer circuitry 906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 910 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906d may be a fractional-N synthesizer or a fractional N/N+1 synthesizer, although the scope of the embodiments is not limited in this respect as other types of frequency synthesizers may be suitable. For example, synthesizer circuitry 906d may be a delta-sigma synthesizer, a frequency multiplier, or a synthesizer comprising a phase-locked loop with a frequency divider.

The synthesizer circuitry 906d may be configured to synthesize an output frequency for use by the mixer circuitry 906a of the RF circuitry 906 based on a frequency input and a divider control input. In some embodiments, the synthesizer circuitry 906d may be a fractional N/N+1 synthesizer.

In some embodiments, frequency input may be provided by a voltage controlled oscillator (VCO), although that is not a requirement. Divider control input may be provided by either the baseband circuitry 910 or the application circuitry 705/805 depending on the desired output frequency. In some embodiments, a divider control input (e.g., N) may be determined from a look-up table based on a channel indicated by the application circuitry 705/805.

Synthesizer circuitry 906d of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path, which may include circuitry configured to operate on RF signals received from antenna array 911, amplify the received signals and provide the amplified versions of the received signals to the RF circuitry 906 for further processing. FEM circuitry 908 may also include a transmit signal path, which may include circuitry configured to amplify signals for transmission provided by the RF circuitry 906 for transmission by one or more of antenna elements of antenna array 911. In various embodiments, the amplification through the transmit or receive signal paths may be done solely in the RF circuitry 906, solely in the FEM circuitry 908, or in both the RF circuitry 906 and the FEM circuitry 908.

In some embodiments, the FEM circuitry 908 may include a TX/RX switch to switch between transmit mode and receive mode operation. The FEM circuitry 908 may include a receive signal path and a transmit signal path. The receive signal path of the FEM circuitry 908 may include an LNA to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission by one or more antenna elements of the antenna array 911.

The antenna array 911 comprises one or more antenna elements, each of which is configured convert electrical signals into radio waves to travel through the air and to convert received radio waves into electrical signals. For example, digital baseband signals provided by the baseband circuitry 910 is converted into analog RF signals (e.g., modulated waveform) that will be amplified and transmitted via the antenna elements of the antenna array 911 including one or more antenna elements (not shown). The antenna elements may be omnidirectional, direction, or a combination thereof. The antenna elements may be formed in a multitude of arranges as are known and/or discussed herein. The antenna array 911 may comprise microstrip antennas or printed antennas that are fabricated on the surface of one or more printed circuit boards. The antenna array 911 may be formed in as a patch of metal foil (e.g., a patch antenna) in a variety of shapes, and may be coupled with the RF circuitry 906 and/or FEM circuitry 908 using metal transmission lines or the like.

Processors of the application circuitry 705/805 and processors of the baseband circuitry 910 may be used to execute elements of one or more instances of a protocol stack. For example, processors of the baseband circuitry 910, alone or in combination, may be used execute Layer 3, Layer 2, or Layer 1 functionality, while processors of the application circuitry 705/805 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

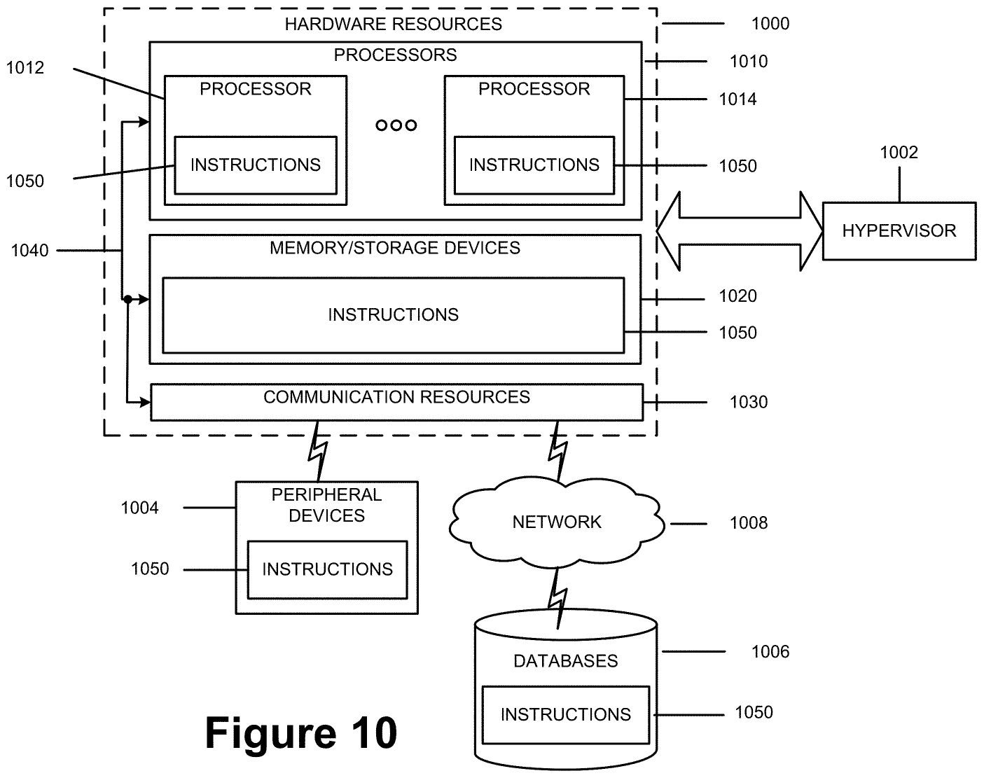

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processor(s) 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via USB), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Example Procedures

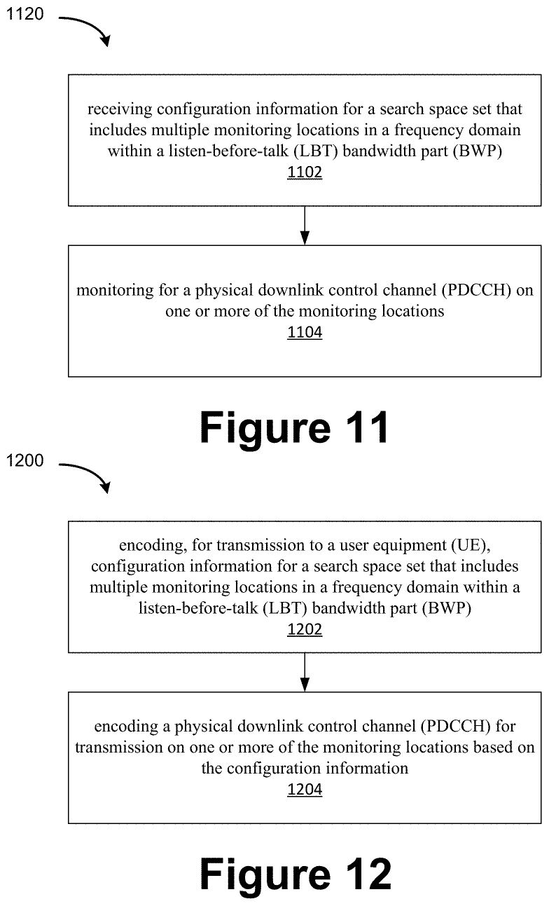

In some embodiments, the electronic device(s), network(s), system(s), chip(s) or component(s), or portions or implementations thereof, of FIGS. 6-10, or some other figure herein, may be configured to perform one or more processes, techniques, or methods as described herein, or portions thereof. One such process 1100 is depicted in FIG. 11. In some embodiments, the process 1100 may be performed by a UE or a portion thereof. For example, the process 1100 may include, at 1102, receiving configuration information for a search space set that includes multiple monitoring locations in a frequency domain within a listen-before-talk (LBT) bandwidth part (BWP). At 1104, the process 1100 may further include monitoring for a physical downlink control channel (PDCCH) on one or more of the monitoring locations.

In some embodiments, the UE may receive an indication of one or more of the monitoring locations that are to be monitored by the UE for the PDCCH. For example, in some embodiments, the indication may be in the form of a bitmap. In some embodiments, individual bits of the bitmap may correspond to respective monitoring locations and/or subbands to indicate whether the UE is to monitor the monitoring locations (and/or the monitoring location within the indicated subband).

FIG. 12 illustrates another example process 1200 in accordance with various embodiments. In some embodiments, the process 1200 may be performed by a gNB or a portion thereof. For example, the process 1200 may include, at 1202, encoding, for transmission to a user equipment (UE), configuration information for a search space set that includes multiple monitoring locations in a frequency domain within a listen-before-talk (LBT) bandwidth part (BWP). At 1204, the process 1200 may further include encoding a physical downlink control channel (PDCCH) for transmission on one or more of the monitoring locations based on the configuration information.

In some embodiments, the gNB may transmit, to the UE, an indication of one or more of the monitoring locations that are to be monitored by the UE for the PDCCH. For example, in some embodiments, the indication may be in the form of a bitmap. In some embodiments, individual bits of the bitmap may correspond to respective monitoring locations and/or subbands to indicate whether the UE is to monitor the monitoring locations (and/or the monitoring location within the indicated subband).

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A01 includes a method of wireless communication for a fifth generation (5G) or new radio (NR) system, the method comprising: transmitting or causing to transmit, by a base station, downlink channels using unlicensed spectrum, wherein transmission of PDSCH depends on the LBT outcomes of each LBT bandwidth.

Example A02 includes the method of example A01 and/or some other example(s) herein, wherein the PDSCH is transmitted only using the LBT bandwidth where CCA is successful.

Example A03 includes the method of example A01 and/or some other example(s) herein, wherein a group common PDCCH is transmitted via one of the LBT bandwidth where CCA is successful.

Example A04 includes the method of example A01 and/or some other example(s) herein, wherein candidate positions for group common PDCCH is positioned in each LBT bandwidth inside the bandwidth part.

Example A05 includes the method of example A01 and/or some other example(s) herein, wherein licensed carrier is used for the transmission of GC-PDCCH.

Example A06 includes the method of example A01 and/or some other example(s) herein, wherein GC-PDCCH is transmitted in the beginning of a COT.

Example A07 includes the method of example A01 and/or some other example(s) herein, wherein GC-PDCCH is transmitted in the middle of a COT.

Example A08 includes the method of example A01 and/or some other example(s) herein, wherein GC-PDCCH is transmitted multiple times inside a COT.

Example A09 includes the method of example A01 and/or some other example(s) herein, wherein for the first part of a COT, PDSCH is encoded using the whole bandwidth parts but actually transmitted using the available LBT bandwidth by puncturing data around the unavailable LBT bandwidth.

Example A10 includes the method of example A01 and/or some other example(s) herein, wherein except for the first part of a COT, PDSCH is encoded by rate matching data around the unavailable LBT bandwidth.

Example A11 includes the method of example A01 and/or some other example(s) herein, wherein a BITMAP is used for indicating available LBT BWs in GC-PDCCH.

Example A12 includes the method of example A01 and/or some other example(s) herein, wherein a GC-PDCCH may indicate that LBT outcome is not available.

Example A13 includes the method of example A01 and/or some other example(s) herein, wherein a cluster-based CORESET is configured for a GC-PDCCH.

Example A14 includes a method comprising: using an RB level offset from a boundary of a guardband to define monitoring occasions of a CORESET in a frequency domain.

Example A14.1 may include the method of Example, A14 or some other example herein, further comprising: monitoring one or more of the monitoring occasions of the CORESET.

Example A15 includes the method of example A01 and/or some other example(s) herein, wherein a CORESET is confined within an LBT bandwidth, and the search space set configuration associated with the CORESET can have multiple monitoring locations in the frequency domain (per LBT bandwidth).

Example A16 includes the method of example A16 and/or some other example(s) herein, wherein a monitoringSubband-r16 parameter is introduced in Searchspace and it shows which LBT subband has to be monitored inside multiple LBT subbands and only one CORESET is configured for a single LBT subband.

Example A17 includes the method of example A16 and/or some other example(s) herein, wherein a bitmap is used for the monitoringSubband-r16 parameter, wherein each bit of the bitmap corresponds to one LBT subband, wherein Max_Subband is the number of LBT subbands that can be configured.

Example A18 includes the method of example A16 and/or some other example(s) herein, wherein a bitmap is used for the monitoringSubband-r16 parameter, wherein each bit of the bitmap corresponds to 6 PRB which is the unit of CORESET which is the unit of CORESET, and each bit of the bitmap indicates the starting point of CORESET that need to be monitored.

Example A19 includes the method of example A15 and/or some other example(s) herein, wherein a monitoringSubband-r16 parameter is introduced in Searchspace and it shows which LBT subband has to be monitored inside multiple LBT subbands, and only one CORESET is configured for a single LBT subband.

Example A20 includes the method of example A19 and/or some other example(s) herein, wherein Multiple offset values are indicated by the monitoringSubband-r16 and each offset indicates the offset of additional monitoring locations in frequency domain with respect to the original CORESET.

Example B01 includes a method comprising: attempting or causing to attempt to decode received downlink control information (DCI); and identifying, based on the decoded DCI, listen-before-talk (LBT) bandwidth (BW) information and a time domain channel occupancy time (COT) structure.

Example B02 includes the method of example B01 and/or some other example(s) herein, wherein the LBT BW information includes a frequency domain COT structure.

Example B03 includes the method of examples B01-B02 and/or some other example(s) herein, wherein the DCI is DCI format 2_0.

Example B04 includes the method of examples B01-B03 and/or some other example(s) herein, further comprising: receiving the DCI over a group common (GC)-Physical Downlink Control Channel (PDCCH).

Example B05 includes the method of example B04 and/or some other example(s) herein, wherein the attempting to decode comprises: attempting or causing to attempt to decode at least one PDCCH candidate for the GC-PDCCH positioned within an available LBT BW.

Example B06 includes the method of examples B04-B05 and/or some other example(s) herein, further comprising: receiving the GC-PDCCH in a licensed band or an unlicensed band.

Example B07 includes the method of examples B04-B06 and/or some other example(s) herein, further comprising: receiving the GC-PDCCH in a next monitoring occasion of the GC-PDCCH if the GC-PDCCH is not prepared in a beginning of a next generation nodeB (gNB) acquired COT.

Example B08 includes the method of examples B04-B07 and/or some other example(s) herein, wherein a Physical Downlink Shared Channel (PDSCH) is mapped assuming that a whole BWP is available, and the LBT BW is punctured where CCA is not successful.

Example B08 includes the method of examples B04-B07 and/or some other example(s) herein, wherein the gNB is to adjust the PDSCH according to available LBT BWs in remaining time of a same COT.

Example B09 includes the method of examples B04-B07 and/or some other example(s) herein, further comprising: performing or causing to perform blind detection of available LBT BWs using a demodulation reference signal (DMRS).

Example B10 includes the method of examples B04-B07 and/or some other example(s) herein, further comprising: attempting or causing to attempt to decode the GC-PDCCH as fast as possible using knowledge of one or more punctured parts.

Example B11 includes the method of example B10 and/or some other example(s) herein, further comprising: performing or causing to perform rate-matching around LBT BWs that are not available due to LBT failure.

Example B12 includes the method of examples B01-B11 and/or some other example(s) herein, further comprising: encoding or causing to encode a Physical Uplink Shared Channel (PUSCH) transmission using a whole scheduled BW; and transmitting or causing to transmit the PUSCH.

Example B13 includes the method of example B12 and/or some other example(s) herein, further comprising: puncturing or causing to puncture data that is mapped to the LBT BW where CCA is not successful.

Example B14 includes the method of example B13 and/or some other example(s) herein, wherein there is one phase and only puncturing is applied for the LBT BW where CCA is not successful during a whole COT duration.

Example B15 includes the method of examples B08-B14 and/or some other example(s) herein, wherein the GC-PDCCH with the indication of the LBT BW is carried in a primary channel and is not prepared in a beginning of the gNB acquired COT.

Example B16 includes the method of example B15 and/or some other example(s) herein, further comprising: during a first phase: attempting or causing to attempt to find the primary channel by detecting a DMRS and/or decoding the GC-PDCCH, unless the primary channel is known a priori or has been already detected in a prior downlink burst; attempting or causing to attempt to decode the GC-PDCCH without any blind detection; extracting or causing to extract the information related to the LBT bandwidth; and during a second phase: performing or causing to perform RF retuning, and attempting or causing to attempt to decode information over an intended activated BWP.

Example B17 includes the method of examples B01-B16 and/or some other example(s) herein, wherein a CORESET is within an LBT BW part (BWP), and a search space set configuration associated with the CORESET includes multiple monitoring locations in a frequency domain per LBT BWP.

Example B18 includes the method of example B17 and/or some other example(s) herein, wherein a monitoringSubband-r16 parameter is introduced in a Searchspace information element (IE) of a received Radio Resource Control (RRC) message.

Example B19 includes the method of example B18 and/or some other example(s) herein, wherein the monitoringSubband-r16 indicates one or more LBT subbands to be monitored inside multiple LBT subbands, and only one CORESET is configured for a single LBT subband.

Example B20 includes the method of example B19 and/or some other example(s) herein, wherein a bitmap is used for the monitoringSubband-r16.

Example B21 includes the method of example B20 and/or some other example(s) herein, wherein each bit of the bitmap corresponds to one LBT subband and Max_Subband is a number of LBT subbands that can be configured; or each bit of the bitmap corresponds to 6 PRB which is the unit of CORESET which is the unit of CORESET, and each bit of the bitmap indicates a starting point of CORESET that need to be monitored.

Example B22 includes the method of example B17 and/or some other example(s) herein, wherein the monitoringSubband-r16 indicates one or more offset values, wherein each of the one or more offset values is an offset of additional monitoring locations in a frequency domain with respect to an original CORESET.

Example B23 includes the method of examples B01-B22 and/or some other example(s) herein, wherein the method is to be performed by a user equipment (UE).

Example C01 includes a method comprising: receiving configuration information for a search space set that includes multiple monitoring locations in a frequency domain within a listen-before-talk (LBT) bandwidth part (BWP); and monitoring for a physical downlink control channel (PDCCH) on one or more of the monitoring locations.

Example C02 includes the method of example C01 and/or some other example(s) herein, wherein individual monitoring locations are within respective subbands of the LBT BWP.

Example C03 includes the method of example C02 and/or some other example(s) herein, wherein the search space set includes one monitoring location per subband.

Example C04 includes the method of example C02-C03 and/or some other example(s) herein, further comprising receiving an indication of one or more of the subbands that are to be monitored for the PDCCH.

Example C05 includes the method of example C04 and/or some other example(s) herein, wherein the indication is received via radio resource control (RRC) signaling.

Example C06 includes the method of example C05 and/or some other example(s) herein, wherein the indication is included in a monitoringSubband-r16 parameter of a Searchspace information element (IE) in an RRC message.

Example C07 includes the method of example C04-006 and/or some other example(s) herein, wherein the indication includes a bitmap.

Example C08 may include the method of example C07 and/or some other example(s) herein, wherein individual bits of the bitmap correspond to respective subbands to indicate whether the associated monitoring occasion is to be monitored.

Example C09 includes the method of example C07-008 and/or some other example(s) herein, wherein individual bits of the bitmap correspond to a number of PRBs that are a unit of a control resource set (CORESET) to indicate a starting point of a CORESET to be monitored.

Example C10 includes the method of example C01-C09 and/or some other example(s) herein, wherein the configuration information includes one or more offset values to indicate an offset of additional monitoring locations in the frequency domain with respect to a reference monitoring location.

Example C11 includes the method of example C01-C10 and/or some other example(s) herein, wherein the respective monitoring locations correspond to one or more resource blocks (RBs) in the frequency domain.

Example C12 includes the method of example C01-C11 and/or some other example(s) herein, wherein the monitoring locations correspond to respective control resource sets (CORESETs).

Example C13 includes the method of examples C01-C12 and/or some other example(s) herein, wherein the method is to be performed by a user equipment (UE).

Example D01 includes a method comprising: encoding, for transmission to a user equipment (UE), configuration information for a search space set that includes multiple monitoring locations in a frequency domain within a listen-before-talk (LBT) bandwidth part (BWP); and encoding a physical downlink control channel (PDCCH) for transmission on one or more of the monitoring locations based on the configuration information.

Example D02 includes the method of example D01 and/or some other example(s) herein, wherein individual monitoring locations are within respective subbands of the LBT BWP.

Example D03 includes the method of example D02 and/or some other example(s) herein, wherein the search space set includes one monitoring location per subband.

Example D04 includes the method of example D02-D03 and/or some other example(s) herein, further comprising encoding, for transmission to the UE, an indication of one or more of the subbands that are to be monitored for the PDCCH.

Example D05 includes the method of example D04 and/or some other example(s) herein, wherein the indication is transmitted via radio resource control (RRC) signaling.

Example D06 includes the method of example D05 and/or some other example(s) herein, wherein the indication is included in a monitoringSubband-r16 parameter of a Searchspace information element (IE) in an RRC message.

Example D07 includes the method of example D04-D06 and/or some other example(s) herein, wherein the indication includes a bitmap.

Example D08 may include the method of example D07 and/or some other example(s) herein, wherein individual bits of the bitmap correspond to respective subbands to indicate whether the associated monitoring occasion is to be monitored by the UE.

Example D09 includes the method of example D07-D08 and/or some other example(s) herein, wherein individual bits of the bitmap correspond to a number of PRBs that are a unit of a control resource set (CORESET) to indicate a starting point of a CORESET to be monitored by the UE.

Example D10 includes the method of example D01-D09 and/or some other example(s) herein, wherein the configuration information includes one or more offset values to indicate an offset of additional monitoring locations in the frequency domain with respect to a reference monitoring location.

Example D11 includes the method of example D01-D10 and/or some other example(s) herein, wherein the respective monitoring locations correspond to one or more resource blocks (RBs) in the frequency domain.

Example D12 includes the method of example D01-D11 and/or some other example(s) herein, wherein the monitoring locations correspond to respective control resource sets (CORESETs).

Example D13 includes the method of examples D01-D12 and/or some other example(s) herein, wherein the method is to be performed by a next generation NodeB (gNB).

Example Z01 may include an apparatus comprising means to perform one or more elements of a method described in or related to any of examples A01-A19, B01-B23, C01-C13, D01-D13 or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A01-A19, B01-B23, C01-C13, D01-D13 or any other method or process described herein.

Example Z03 may include an apparatus comprising logic, modules, or circuitry to perform one or more elements of a method described in or related to any of examples A01-A19, B01-B23, C01-C13, D01-D13 or any other method or process described herein.

Example Z04 may include a method, technique, or process as described in or related to any of examples A01-A19, B01-B23, C01-C13, D01-D13 or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A01-A19, B01-B23, C01-C13, D01-D13 or portions thereof.

Example Z06 may include a signal as described in or related to any of examples A01-A19, B01-B23, C01-C13, D01-D13 or portions or parts thereof.

Example Z07 may include a datagram, packet, frame, segment, protocol data unit (PDU), or message as described in or related to any of examples A01-A19, B01-B23, C01-C13, D01-D13 or portions or parts thereof, or otherwise described in the present disclosure.

Example Z08 may include a signal encoded with data as described in or related to any of examples A01-A19, B01-B23, C01-C13, D01-D13 or portions or parts thereof, or otherwise described in the present disclosure.

Example Z09 may include a signal encoded with a datagram, packet, frame, segment, protocol data unit (PDU), or message as described in or related to any of examples A01-A19, B01-B23, C01-C13, D01-D13 or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A01-A19, B01-B23, C01-C13, D01-D13 or portions thereof.

Example Z11 may include a computer program comprising instructions, wherein execution of the program by a processing element is to cause the processing element to carry out the method, techniques, or process as described in or related to any of examples A01-A19, B01-B23, C01-C13, D01-D13 or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

For the purposes of the present document, the following abbreviations may apply to the examples and embodiments discussed herein.

| | | |
|---|---|---|
| 3GPP Third Generation | ASN.1 Abstract Syntax | Certification |
| Partnership Project | Notation One | Authority |
| 4G Fourth Generation | AUSF Authentication | CAPEX CAPital |
| 5G Fifth Generation | Server Function | EXpenditure |
| 5GC 5G Core network | AWGN Additive | CBRA Contention Based |
| ACK Acknowledgement | White Gaussian | Random Access |
| AF Application | Noise | CC Component Carrier, |
| Function | BAP Backhaul | Country Code, |
| AM Acknowledged | Adaptation Protocol | Cryptographic |
| Mode | BCH Broadcast Channel | Checksum |
| AMBRAggregate | BER Bit Error Ratio | CCA Clear Channel |
| Maximum Bit Rate | BFD Beam Failure | Assessment |
| AMF Access and | Detection | CCE Control Channel |
| Mobility | BLER Block Error Rate | Element |
| Management | BPSK Binary Phase Shift | CCCH Common Control |
| Function | Keying | Channel |
| AN Access Network | BRAS Broadband Remote | CE Coverage |
| ANR Automatic | Access Server | Enhancement |
| Neighbour Relation | BSS Business Support | CDM Content Delivery |
| AP Application | System | Network |
| Protocol, Antenna | BS Base Station | CDMA Code- |
| Port, Access Point | BSR Buffer Status | Division Multiple |
| API Application | Report | Access |
| Programming Interface | BW Bandwidth | CFRA Contention Free |
| APN Access Point Name | BWP Bandwidth Part | Random Access |
| ARP Allocation and | C-RNTI Cell Radio | CG Cell Group |
| Retention Priority | Network Temporary | CI Cell Identity |
| ARQ Automatic Repeat | Identity | CID Cell-ID (e.g., |
| Request | CA Carrier | positioning method) |
| AS Access Stratum | Aggregation, | CIM Common |
| CIR Carrier to | CPU CSI processing | Information Model |
| Interference Ratio | unit, Central Processing | CSI-RSRQ CSI |
| CK Cipher Key | Unit | reference signal |
| CM Connection | C/R | received quality |
| Management, Conditional | Command/Response | CSI-SINR CSI signal- |
| Mandatory | field bit | to-noise and interference |
| CMAS Commercial | CRAN Cloud Radio | ratio |
| Mobile Alert Service | Access Network, | CSMA Carrier Sense |
| CMD Command | Cloud RAN | Multiple Access |
| CMS Cloud Management | CRB Common Resource | CSMA/CA CSMA with |
| System | Block | collision avoidance |
| CO Conditional | CRC Cyclic Redundancy | CSS Common Search |
| Optional | Check | Space, Cell- specific |
| CoMP Coordinated Multi- | CRI Channel-State | Search Space |
| Point | Information Resource | CTS Clear-to-Send |
| CORESET Control | Indicator, CSI-RS | CW Codeword |
| Resource Set | Resource Indicator | CWS Contention |
| COTS Commercial Off- | C-RNTI Cell RNTI | Window Size |
| The-Shelf | CS Circuit Switched | D2D Device-to-Device |
| CP Control Plane, | CSAR Cloud Service | DC Dual Connectivity, |
| Cyclic Prefix, Connection | Archive | Direct Current |
| Point | CSI Channel-State | DCI Downlink Control |
| CPD Connection Point | Information | Information |
| Descriptor | CSI-IM CSI | DF Deployment |
| CPE Customer Premise | Interference | Flavour |
| Equipment | Measurement | DL Downlink |
| CPICHCommon Pilot | CSI-RS CSI | DMTF Distributed |
| Channel | Reference Signal | Management Task Force |
| CQI Channel | CSI-RSRP CSI | DPDK Data Plane |
| Quality | reference signal | Development |
| Indicator | received power | Kit |
| DM-RS, DMRS | Management | EREG enhanced REG, |
| Demodulation | Function | enhanced resource |
| Reference Signal | EGPRS Enhanced | element groups |
| DN Data network | GPRS | ETSI European |
| DRB Data Radio Bearer | EIR Equipment Identity | Telecommunications |
| DRS Discovery | Register | Standards Institute |
| Reference Signal | eLAA enhanced Licensed | ETWS Earthquake and |
| DRX Discontinuous | Assisted Access, | Tsunami Warning |
| Reception | enhanced LAA | System |
| DSL Domain Specific | EM Element Manager | eUICC embedded UICC, |
| Language. Digital | eMBB Enhanced Mobile | embedded Universal |
| Subscriber Line | Broadband | Integrated Circuit Card |
| DSLAM DSL Access | EMS Element | E-UTRA Evolved |
| Multiplexer | Management System | UTRA |
| DwPTS Downlink | eNB evolved NodeB, E- | E-UTRAN Evolved |
| Pilot Time Slot | UTRAN Node B | UTRAN |
| E-LAN Ethernet | EN-DC E-UTRA- | EV2X Enhanced V2X |
| Local Area Network | NR Dual | F1AP F1 Application |
| E2E End-to-End | Connectivity | Protocol |
| ECCA extended clear | EPC Evolved Packet | F1-C F1 Control plane |
| channel assessment, | Core | interface |
| extended CCA | EPDCCH enhanced | F1-U F1 User plane |
| ECCE Enhanced Control | PDCCH, enhanced | interface |
| Channel Element, | Physical Downlink | FACCH Fast |
| Enhanced CCE | Control Cannel | Associated Control |
| ED Energy Detection | EPRE Energy per | CHannel |
| EDGE Enhanced Datarates | resource element | FACCH/F Fast |
| for GSM Evolution | EPS Evolved Packet | Associated Control |
| (GSM Evolution) | System | Channel/Full rate |
| EGMF Exposure | FN Frame Number | GNSS Global Navigation |
| Governance | FPGA Field- | Satellite System |
| FACCH/H Fast | Programmable Gate | GPRS General Packet |
| Associated Control | Array | Radio Service |
| Channel/Half rate | FR Frequency Range | GSM Global System for |
| FACH Forward Access | G-RNTI GERAN | Mobile |
| Channel | Radio Network | Communications, |
| FAUSCH Fast Uplink | Temporary Identity | Groupe Special |
| Signalling Channel | GERAN | Mobile |
| FB Functional Block | GSM EDGE RAN, | GTP GPRS Tunneling |
| FBI Feedback | GSM EDGE Radio | Protocol |
| Information | Access Network | GTP-UGPRS Tunnelling |
| FCC Federal | GGSN Gateway GPRS | Protocol for User |
| Communications | Support Node | Plane |
| Commission | GLONASS | GTS Go To Sleep Signal |
| FCCH Frequency | GLObal'naya | (related to WUS) |
| Correction CHannel | NAvigatsionnaya | GUMMEI Globally |
| FDD Frequency Division | Sputnikovaya | Unique MME Identifier |
| Duplex | Sistema (Engl.: | GUTI Globally Unique |
| FDM Frequency Division | Global Navigation | Temporary UE Identity |
| Multiplex | Satellite System) | HARQ Hybrid ARQ, |
| FDMAFrequency Division | gNB Next Generation | Hybrid Automatic |
| Multiple Access | NodeB | Repeat Request |
| FE Front End | gNB-CU gNB- | HANDO Handover |
| FEC Forward Error | centralized unit, Next | HFN HyperFrame |
| Correction | Generation NodeB | Number |
| FFS For Further Study | centralized unit | HHO Hard Handover |
| FFT Fast Fourier | gNB-DU gNB- | HLR Home Location |
| Transformation | distributed unit, Next | Register |
| feLAA further enhanced | Generation NodeB | HN Home Network |
| Licensed Assisted | distributed unit | HO Handover |
| Access, further | IDFT Inverse Discrete | IMPU IP Multimedia |
| enhanced LAA | Fourier Transform | PUblic identity |
| HPLMN Home | IE Information | IMS IP Multimedia |
| Public Land Mobile | element | Subsystem |
| Network | IBE In-Band Emission | IMSI International |
| HSDPA High Speed | IEEE Institute of | Mobile Subscriber |
| Downlink Packet | Electrical and | Identity |
| Access | Electronics | IoT Internet of Things |
| HSN Hopping Sequence | Engineers | IP Internet Protocol |
| Number | IEI Information | Ipsec IP Security, |
| HSPA High Speed Packet | Element Identifier | Internet Protocol |
| Access | IEIDL Information | Security |
| HSS Home Subscriber | Element Identifier | IP-CAN IP- |
| Server | Data Length | Connectivity Access |
| HSUPA High Speed | IETF Internet | Network |
| Uplink Packet Access | Engineering Task | IP-M IP Multicast |
| HTTP Hyper Text | Force | IPv4 Internet Protocol |
| Transfer Protocol | IF Infrastructure | Version 4 |
| HTTPS Hyper Text | IM Interference | IPv6 Internet Protocol |
| Transfer Protocol | Measurement, | Version 6 |
| Secure (https is | Intermodulation, IP | IR Infrared |
| http/1.1 over SSL, | Multimedia | IS In Sync |
| i.e. port 443) | IMC IMS Credentials | IRP Integration |
| I-Block Information | IMEI International | Reference Point |
| Block | Mobile Equipment | ISDN Integrated Services |
| ICCID Integrated Circuit | Identity | Digital Network |
| Card Identification | IMGI International | ISIIVI IM Services |
| IAB Integrated Access | mobile group identity | Identity Module |
| and Backhaul | IMPI IP Multimedia | ISO International |
| ICIC Inter-Cell | Private Identity | Organisation for |
| Interference | L2 Layer 2 (data link | Standardisation |
| Coordination | layer) | LWIP LTE/WLAN Radio |
| ID Identity, identifier | L3 Layer 3 (network | Level Integration with |
| ISP Internet Service | layer) | IPsec Tunnel |
| Provider | LAA Licensed Assisted | LTE Long Term |
| IWF Interworking- | Access | Evolution |
| Function | LAN Local Area | M2M Machine-to- |
| I-WLAN | Network | Machine |
| Interworking | LBT Listen Before Talk | MAC Medium Access |
| WLAN | LCM LifeCycle | Control (protocol |
| Constraint length of | Management | layering context) |
| the convolutional code, | LCR Low Chip Rate | MAC Message |
| USIM Individual key | LCS Location Services | authentication code |
| kB Kilobyte (1000 | LCID Logical | (security/encryption |
| bytes) | Channel ID | context) |
| kbps kilo-bits per second | LI Layer Indicator | MAC-A MAC used |
| Kc Ciphering key | LLC Logical Link | for authentication and |
| Ki Individual | Control, Low Layer | key agreement (TSG T |
| subscriber | Compatibility | WG3 context) |
| authentication key | LPLMN Local | MAC-IMAC used for data |
| KPI Key Performance | PLMN | integrity of |
| Indicator | LPP LTE Positioning | signalling messages (TSG |
| KQI Key Quality | Protocol | T WG3 context) |
| Indicator | LSB Least Significant | MANO |
| KSI Key Set Identifier | Bit | Management and |
| ksps kilo-symbols per | LTE Long Term | Orchestration |
| second | Evolution | MBMS Multimedia |
| KVM Kernel Virtual | LWA LTE-WLAN | Broadcast and Multicast |
| Machine | aggregation | Service |
| L1 Layer 1 (physical | MM Mobility | MB SFN Multimedia |
| layer) | Management | Broadcast multicast |
| L1-RSRP Layer 1 | MME Mobility | MSI Minimum System |
| reference signal | Management Entity | Information, MCH |
| received power | MN Master Node | Scheduling |
| service Single Frequency | MO Measurement | Information |
| Network | Object, Mobile | MSID Mobile Station |
| MCC Mobile Country | Originated | Identifier |
| Code | MPBCH MTC | MSIN Mobile Station |
| MCG Master Cell Group | Physical Broadcast | Identification |
| MCOT Maximum Channel | CHannel | Number |
| Occupancy Time | MPDCCH MTC | MSISDN Mobile |
| MCS Modulation and | Physical Downlink | Subscriber ISDN |
| coding scheme | Control CHannel | Number |
| MDAF Management Data | MPDSCH MTC | MT Mobile Terminated, |
| Analytics Function | Physical Downlink | Mobile Termination |
| MDAS Management Data | Shared CHannel | MTC Machine-Type |
| Analytics Service | MPRACH MTC | Communications |
| MDT Minimization of | Physical Random | mMTCmassive MTC, |
| Drive Tests | Access CHannel | massive Machine- |
| ME Mobile Equipment | MPUSCH MTC | Type Communications |
| MeNB master eNB | Physical Uplink Shared | MU-MIMO Multi User |
| MER Message Error | Channel | MIMO |
| Ratio | MPLS MultiProtocol | MWUS MTC wake- |
| MGL Measurement Gap | Label Switching | up signal, MTC |
| Length | MS Mobile Station | WUS |
| MGRP Measurement Gap | MSB Most Significant | NACK Negative |
| Repetition Period | Bit | Acknowledgement |
| MIB Master Information | MSC Mobile Switching | NAI Network Access |
| Block, Management | Centre | Identifier |
| Information Base | N-PoP Network Point of | NAS Non-Access |
| MIMO Multiple Input | Presence | Stratum, Non-Access |
| Multiple Output | NMIB, N-MIB | Stratum layer |
| MLC Mobile Location | Narrowband MIB | NRS Narrowband |
| Centre | NPBCH Narrowband | Reference Signal |
| NCT Network | Physical Broadcast | NS Network Service |
| Connectivity Topology | CHannel | NSA Non-Standalone |
| NC-JT Non- | NPDCCH Narrowband | operation mode |
| Coherent Joint | Physical Downlink | NSD Network Service |
| Transmission | Control CHannel | Descriptor |
| NEC Network Capability | NPDSCH Narrowband | NSR Network Service |
| Exposure | Physical Downlink | Record |
| NE-DC NR-E- | Shared CHannel | NS SAINetwork Slice |
| UTRA Dual | NPRACH Narrowband | Selection Assistance |
| Connectivity | Physical Random | Information |
| NEF Network Exposure | Access CHannel | S-NNSAI Single- |
| Function | NPUSCH Narrowband | NS SAI |
| NF Network Function | Physical Uplink | NSSF Network Slice |
| NFP Network | Shared CHannel | Selection Function |
| Forwarding Path | NPSS Narrowband | NW Network |
| NFPD Network | Primary | NWUSNarrowband wake- |
| Forwarding Path | Synchronization | up signal, Narrowband |
| Descriptor | Signal | WUS |
| NFV Network Functions | NSSS Narrowband | NZP Non-Zero Power |
| Virtualization | Secondary | O&M Operation and |
| NFVI NFV Infrastructure | Synchronization | Maintenance |
| NFVO NFV Orchestrator | Signal | ODU2 Optical channel |
| NG Next Generation, | NR New Radio, | Data Unit-type 2 |
| Next Gen | Neighbour Relation | OFDM Orthogonal |
| NGEN-DC NG-RAN | NRF NF Repository | Frequency Division |
| E-UTRA-NR Dual | Function | Multiplexing |
| Connectivity | PCRF Policy Control and | OFDMA Orthogonal |
| NM Network Manager | Charging Rules | Frequency Division |
| NMS Network | Function | Multiple Access |
| Management System | PDCP Packet Data | PIN Personal |
| OOB Out-of-band | Convergence Protocol, | Identification Number |
| OOS Out of Sync | Packet Data | PM Performance |
| OPEX OPerating EXpense | Convergence | Measurement |
| OSI Other System | Protocol layer | PMI Precoding Matrix |
| Information | PDCCH Physical | Indicator |
| OSS Operations Support | Downlink Control | PNF Physical Network |
| System | Channel | Function |
| OTA over-the-air | PDCP Packet Data | PNFD Physical Network |
| PAPR Peak-to-Average | Convergence Protocol | Function Descriptor |
| Power Ratio | PDN Packet Data | PNFR Physical Network |
| PAR Peak to Average | Network, Public Data | Function Record |
| Ratio | Network | POC PTT over Cellular |
| PBCH Physical Broadcast | PDSCH Physical | PP, PTP Point-to- |
| Channel | Downlink Shared | Point |
| PC Power Control, | Channel | PPP Point-to-Point |
| Personal Computer | PDU Protocol Data Unit | Protocol |
| PCC Primary | PEI Permanent | PRACH Physical |
| Component Carrier, | Equipment Identifiers | RACH |
| Primary CC | PFD Packet Flow | PRB Physical resource |
| PCell Primary Cell | Description | block |
| PCI Physical Cell ID, | P-GW PDN Gateway | PRG Physical resource |
| Physical Cell | PHICH Physical | block group |
| Identity | hybrid-ARQ indicator | ProSe Proximity Services, |
| PCEF Policy and | channel | Proximity-Based |
| Charging | PHY Physical layer | Service |
| Enforcement | PLMN Public | PRS Positioning |
| Function | Land Mobile | Reference Signal |
| PCF Policy Control | Network | PRR Packet Reception |
| Function | QCL Quasi | Radio |
| PSBCH Physical | co-location | PS Packet Services |
| Sidelink Broadcast | QFI QoS | RB Resource block, |
| Channel | Flow ID, QoS | Radio Bearer |
| PSDCH Physical | Flow Identifier | RBG Resource block |
| Sidelink Downlink | QoS Quality | group |
| Channel | of Service | REG Resource Element |
| PSCCH Physical | QPSK Quadrature | Group |
| Sidelink Control | (Quaternary) | Rel Release |
| Channel | Phase Shift | REQ REQuest |
| PSSCH Physical | Keying | RF Radio Frequency |
| Sidelink Shared | QZSS Quasi-Zenith | RI Rank Indicator |
| Channel | Satellite System | MV Resource indicator |
| PSCell Primary SCell | RA-RNTI Random | value |
| PSS Primary | Access RNTI | RL Radio Link |
| Synchronization | RAB Radio Access | RLC Radio Link |
| Signal | Bearer, Random | Control, Radio Link |
| PSTN Public Switched | Access Burst | Control layer |
| Telephone Network | RACH Random Access | RLC AM RLC |
| PT-RS Phase-tracking | Channel | Acknowledged Mode |
| reference signal | RADIUS Remote | RLC UM RLC |
| PTT Push-to-Talk | Authentication Dial In | Unacknowledged Mode |
| PUCCH Physical | User Service | RLF Radio Link Failure |
| Uplink Control | RAN Radio Access | RLM Radio Link |
| Channel | Network | Monitoring |
| PUSCH Physical | RAND | RLM-RS Reference |
| Uplink Shared | RANDom number | Signal for RLM |
| Channel | (used for | RM Registration |
| QAM Quadrature | authentication) | Management |
| Amplitude Modulation | RAR Random Access | RMC Reference |
| QCI QoS class of | Response | Measurement Channel |
| identifier | RAT Radio Access | Division Multiple |
| RMSI Remaining MSI, | Technology | Access |
| Remaining Minimum | RAU Routing Area | SCG Secondary Cell |
| System Information | Update | Group |
| RN Relay Node | Rx Reception, | SCM Security Context |
| RNC Radio Network | Receiving, Receiver | Management |
| Controller | S1AP S1 Application | SCS Subcarrier Spacing |
| RNL Radio Network | Protocol | SCTP Stream Control |
| Layer | S1-MME S1 for the | Transmission |
| RNTI Radio Network | control plane | Protocol |
| Temporary Identifier | Sl-U S1 for the user | SDAP Service Data |
| ROHC RObust Header | plane | Adaptation Protocol, |
| Compression | S-GW Serving Gateway | Service Data Adaptation |
| RRC Radio Resource | S-RNTI SRNC | Protocol layer |
| Control, Radio | Radio Network | SDL Supplementary |
| Resource Control layer | Temporary Identity | Downlink |
| RRM Radio Resource | S-TMSI SAE | SDNF Structured Data |
| Management | Temporary Mobile | Storage Network |
| RS Reference Signal | Station Identifier | Function |
| RSRP Reference Signal | SA Standalone | SDP Session Description |
| Received Power | operation mode | Protocol |
| RSRQ Reference Signal | SAE System | SDSF Structured Data |
| Received Quality | Architecture Evolution | Storage Function |
| RSSI Received Signal | SAP Service Access | SDU Service Data Unit |
| Strength Indicator | Point | SEAF Security Anchor |
| RSU Road Side Unit | SAPD Service Access | Function |
| RSTD Reference Signal | Point Descriptor | SeNB secondary eNB |
| Time difference | SAPI Service Access | SEPP Security Edge |
| RTP Real Time Protocol | Point Identifier | Protection Proxy |
| RTS Ready-To-Send | SCC Secondary | SFI Slot format |
| RTT Round Trip Time | Component Carrier, | indication |
| SFTD Space-Frequency | Secondary CC | SS-RSRP |
| Time Diversity, SFN and | SCell Secondary Cell | Synchronization |
| frame timing difference | SC-FDMA Single | Signal based Reference |
| SFN System Frame | Carrier Frequency | Signal Received |
| Number | SMTC SSB-based | Power |
| SgNB Secondary gNB | Measurement Timing | SS-RSRQ |
| SGSN Serving GPRS | Configuration | Synchronization |
| Support Node | SN Secondary Node, | Signal based Reference |
| S-GW Serving Gateway | Sequence Number | Signal Received |
| SI System Information | SoC System on Chip | Quality |
| SI-RNTI System | SON Self-Organizing | SS-SINR |
| Information RNTI | Network | Synchronization |
| SIB System Information | SpCell Special Cell | Signal based Signal to |
| Block | SP-CSI-RNTISemi- | Noise and Interference |
| SIM Subscriber Identity | Persistent CSI RNTI | Ratio |
| Module | SPS Semi-Persistent | SSS Secondary |
| SIP Session Initiated | Scheduling | Synchronization |
| Protocol | SQN Sequence number | Signal |
| SiP System in Package | SR Scheduling Request | SSSG Search Space Set |
| SL Sidelink | SRB Signalling Radio | Group |
| SLA Service Level | Bearer | SSSIF Search Space Set |
| Agreement | SRS Sounding | Indicator |
| SM Session | Reference Signal | SST Slice/Service Types |
| Management | SS Synchronization | SU-MIMO Single User |
| SMF Session | Signal | MIMO |
| Management Function | SSB Synchronization | SUL Supplementary |
| SMS Short Message | Signal Block, SS/PBCH | Uplink |
| Service | Block | TA Timing Advance, |
| SMSF SMS Function | SSBRI SS/PBCH Block | Tracking Area |
| TAG Timing Advance | Resource Indicator, | TAC Tracking Area |
| Group | Synchronization | Code |
| TAU Tracking Area | Signal Block | UDP User Datagram |
| Update | Resource Indicator | Protocol |
| TB Transport Block | SSC Session and Service | UDSF Unstructured Data |
| TBS Transport Block | Continuity | Storage Network |
| Size | TPMI Transmitted | Function |
| TBD To Be Defined | Precoding Matrix | UICC Universal |
| TCI Transmission | Indicator | Integrated Circuit Card |
| Configuration Indicator | TR Technical Report | UL Uplink |
| TCP Transmission | TRP, TRxP | UM Unacknowledged |
| Communication | Transmission | Mode |
| Protocol | Reception Point | UML Unified Modelling |
| TDD Time Division | TRS Tracking Reference | Language |
| Duplex | Signal | UMTS Universal Mobile |
| TDM Time Division | TRx Transceiver | Telecommunications |
| Multiplexing | TS Technical | System |
| TDMATime Division | Specifications, | UP User Plane |
| Multiple Access | Technical Standard | UPF User Plane |
| TE Terminal | TTI Transmission Time | Function |
| Equipment | Interval | URI Uniform Resource |
| TEID Tunnel End Point | Tx Transmission, | Identifier |
| Identifier | Transmitting, | URL Uniform Resource |
| TFT Traffic Flow | Transmitter | Locator |
| Template | U-RNTI UTRAN | URLLC Ultra- |
| TMSI Temporary Mobile | Radio Network | Reliable and Low |
| Subscriber Identity | Temporary Identity | Latency |
| TNL Transport Network | UART Universal | USB Universal Serial |
| Layer | Asynchronous | Bus |
| TPC Transmit Power | Receiver and | USIM Universal |
| Control | Transmitter | Subscriber Identity Module |
| UTRA UMTS Terrestrial | UCI Uplink Control | USS UE-specific search |
| Radio Access | Information | space |
| UTRAN Universal | UE User Equipment | |
| Terrestrial Radio | UDM Unified Data | |
| Access Network | Management | |
| UwPTS Uplink Pilot | VoIP Voice-over-IP, | |
| Time Slot | Voice-over-Internet | |
| V2I Vehicle-to- | Protocol | |
| Infrastruction | VPLMN Visited | |
| V2P Vehicle-to- | Public Land Mobile | |
| Pedestrian | Network | |
| V2V Vehicle-to-Vehicle | VPN Virtual Private | |
| V2X Vehicle-to- | Network | |
| everything | VRB Virtual Resource | |
| VIM Virtualized | Block | |
| Infrastructure Manager | WiMAX Worldwide | |
| VL Virtual Link, | Interoperability for | |
| VLAN Virtual LAN, | Microwave Access | |
| Virtual Local Area | WLANWireless Local | |
| Network | Area Network | |
| VM Virtual Machine | WMAN Wireless | |
| VNF Virtualized | Metropolitan Area | |
| Network Function | Network | |
| VNFFG VNF | WPAN Wireless Personal | |
| Forwarding Graph | Area Network | |
| VNFFGD VNF | X2-C X2-Control plane | |
| Forwarding Graph | X2-U X2-User plane | |
| Descriptor | XML eXtensible Markup | |
| VNFM VNF Manager | Language | |
| | XRES EXpected user | |
| | RESponse | |
| | XOR eXclusive OR | |
| | ZC Zadoff-Chu | |
| | ZP Zero Power | |

### Terminology

For the purposes of the present document, the following terms and definitions are applicable to the examples and embodiments discussed herein.

The term “circuitry” refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), complex PLD (CPLD), high-capacity PLD (HCPLD), System-on-Chip (SoC), System-in-Package (SiP), Multi-Chip Package (MCP), digital signal processor (DSP), etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including random access memory (RAM), magnetoresistive RAM (MRAM), phase change random access memory (PRAM), dynamic random access memory (DRAM) and/or synchronous dynamic random access memory (SDRAM), core memory, read only memory (ROM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “information element” refers to a structural element containing one or more fields. The term “field” refers to individual contents of an information element, or a data element that contains content.

The term “admission control” refers to a validation process in communication systems where a check is performed before a connection is established to see if current resources are sufficient for the proposed connection.

The term “workload” refers to an amount of work performed by a computing system, device, entity, etc., during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by the processor 102 during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, etc.), and/or the like. Various algorithms may be used to determine a workload and/or workload characteristics, which may be based on any of the aforementioned workload types.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell. When a UE in RRC_CONNECTED configured with CA/DC, the term “serving cell” refers to the set of cells comprising the Special Cell(s) and all secondary cells.

The term “Special Cell” refers to the PCell of the MCG or the PSCell of the SCG for DC operation; otherwise, the term “Special Cell” refers to the Pcell.

1. One or more non-transitory computer-readable media (NTCRM) having instructions, stored thereon, that when executed are to cause a user equipment (UE) to:
receive configuration information for a search space set that includes multiple monitoring locations in a frequency domain within a listen-before-talk (LBT) bandwidth part (BWP); and
monitor for a physical downlink control channel (PDCCH) on one or more of the monitoring locations.

2. The one or more NTCRM of claim 1, wherein individual monitoring locations are within respective subbands of the LBT BWP.

3. The one or more NTCRM of claim 2, wherein the instructions, when executed, are further to cause the UE to receive an indication of one or more of the subbands that are to be monitored for the PDCCH.

4. The one or more NTCRM of claim 3, wherein the indication is received via radio resource control (RRC) signaling.

5. The one or more NTCRM of claim 4, wherein the indication is included in a monitoringSubband-r16 parameter of a Searchspace information element (IE) in an RRC message.

6. The one or more NTCRM of claim 3, wherein the indication includes a bitmap.

7. The one or more NTCRM of claim 6, wherein individual bits of the bitmap correspond to respective subbands to indicate whether the associated monitoring occasion is to be monitored.

8. The one or more NTCRM of claim 6, wherein individual bits of the bitmap correspond to a number of PRBs that are a unit of a control resource set (CORESET) to indicate a starting point of a CORESET to be monitored.

9. The one or more NTCRM of claim 1, wherein the respective monitoring locations correspond to one or more resource blocks (RBs) in the frequency domain.

10. The one or more NTCRM of claim 1, wherein the monitoring locations correspond to respective control resource sets (CORESETs).

11. One or more non-transitory computer-readable media (NTCRM) having instructions, stored thereon, that when executed are to cause a next generation NodeB (gNB) to:
encode, for transmission to a user equipment (UE), configuration information for a search space set that includes multiple monitoring locations in a frequency domain within a listen-before-talk (LBT) bandwidth part (BWP); and
encode a physical downlink control channel (PDCCH) for transmission on one or more of the monitoring locations based on the configuration information.

12. The one or more NTCRM of claim 11, wherein individual monitoring locations are within respective subbands of the LBT BWP.

13. The one or more NTCRM of claim 12, wherein the instructions, when executed, are further to cause the gNB to: encode, for transmission to the UE, an indication of one or more of the subbands that are to be monitored for the PDCCH.

14. The one or more NTCRM of claim 13, wherein the indication is transmitted via radio resource control (RRC) signaling.

15. The one or more NTCRM of claim 14, wherein the indication is included in a monitoringSubband-r16 parameter of a Searchspace information element (IE) in an RRC message.

16. The one or more NTCRM of claim 13, wherein the indication includes a bitmap.

17. The one or more NTCRM of claim 16, wherein individual bits of the bitmap correspond to respective subbands to indicate whether the associated monitoring occasion is to be monitored by the UE.

18. The one or more NTCRM of claim 16, wherein individual bits of the bitmap correspond to a number of PRBs that are a unit of a control resource set (CORESET) to indicate a starting point of a CORESET to be monitored by the UE.

19. The one or more NTCRM of claim 11, wherein the respective monitoring locations correspond to one or more resource blocks (RBs) in the frequency domain.

20. The one or more NTCRM of claim 11, wherein the monitoring locations correspond to respective control resource sets (CORESETs).
